(19) United States
(12) Patent Application Publication
(10) Pub. No.: US 2017/0015537 A1
(43) Pub. Date: Jan. 19, 2017

(54) Lifting fork positioning system

(71) Applicants: George R. Bosworth, III, East Palestine, OH (US); Christopher R. Andric, Lisbon, OH (US)

(72) Inventors: George R. Bosworth, III, East Palestine, OH (US); Christopher R. Andric, Lisbon, OH (US)

(21) Appl. No.: 14/999,865

(22) Filed: Jul. 12, 2016

Related U.S. Application Data
(60) Provisional application No. 62/231,638, filed on Jul. 13, 2015.

(51) Int. Cl. B66F 9/075; B66F 17/00; B60K 35/00; B66F 9/07

(52) U.S. Cl. CPC B66F 9/0755; B66F 9/07; B66F 17/003; B60K 35/00; B60K 2350/1084; B60K 2350/1004

(57) ABSTRACT

A lifting fork positioning system to guide movement of a lifting vehicle to properly position one or more lifting forks thereof relative to a pallet may include a sensor device to be mounted adjacent to (and for movement with) a vertical portion of one or more lifting forks thereof to enable detection of a distance to a front face of a palletized load, and a console device to be mounted in the vicinity of manually operable controls of the lifting vehicle to present an operator thereof with an indication of the position of a front face of the palletized load relative to the one or more lifting forks, wherein a processor component of the lifting fork positioning system may employ a received indication of a zero point distance to derive the indication of the position of the front face of the palletized load that is presented to the operator.

### REFERENCE TO PROVISIONAL APPLICATION

This Utility Application claims the benefit of the filing date of Provisional Application Ser. No. 62/231,638 filed Jul. 13, 2015 by George Ronald Bosworth, III and Christopher Richard Andric, the disclosure of which is incorporated herein by reference.

### BACKGROUND

The present invention relates to the field of materials handling—specifically to devices and methods to prevent accidents in the handling of palletized loads that can result in injury to personnel, as well as damage to the palletized loads, handling equipment and/or facilities in which the palletized loads are handled.

Lifting vehicles employing lifting forks, such as forklifts, have long been in common use in warehousing and/or shipping facilities to assist in storing, retrieving and/or moving palletized loads. Over many decades, pallets have become widely accepted as the basis of a system of organization in which items of a wide variety of shapes, sizes, weights, etc., can be stored, tracked and/or transported. Each pallet provides a surface atop which one or more items of widely varying characteristics can be supported, either directly, or within one or more containers. Any of a variety of types of containers may be supported atop a pallet to contain such items, including and not limited to, cardboard boxes, plastic and/or wooden storage containers, plastic and/or metal barrels, and/or metal cages. Such items and/or the containers in which such items are contained may be secured to a pallet by any of a variety of mechanisms, including and not limited to, plastic and/or metal strapping, elastic cords, gluing, bolting, and/or horizontally wound plastic wrapping.

In being placed atop and/or secured to a pallet, one or more items so placed and/or secured may be said to have been “palletized” to enable the handling thereof as a palletized load using any of a wide variety of lifting vehicles found in storing and/or shipping facilities around the world, including forklifts. Stated differently, once one or more items become palletized, the handling of those items effectively becomes the handling of a palletized load. Over time, to provide some degree of interoperability among lifting vehicles and pallets of many different designs provided by many manufacturers in many industries and in many places around the world, some degree of standardization has taken place concerning such details as the shapes, sizes and/or quantities of the lifting forks carried by lifting vehicles, and in the locations formed within pallets to receive lifting forks to lift a pallet. More specifically, an effort has been made to agree upon enough aspects of the manner in which pallets are designed to at least somewhat minimize instances in which the lifting forks carried by a lifting vehicle must be repositioned to change their spacing and/or must be replaced with other lifting forks of different dimensions.

By way of example, over time, a degree of consensus has developed concerning the dimensions for the vertical thickness of lifting forks, as well as concerning the vertical clearance in the fork receiving locations formed in pallets to receive lifting forks. As a result, it has become uncommon to encounter a situation in which the lifting forks of a lifting vehicle are found to be vertically too thick to fit within the vertical clearance provided by the fork receiving locations of a pallet.

Unfortunately, while such strides have been made in standardizing some of such aspects of pallets, other aspects have become more varied. More specifically, variations in the overall horizontal dimensions of palettes have developed such that there has come to be a proliferation in pallet sizes that each provide supporting surfaces of different dimensions. By way of example, the International Organization for Standardization (ISO) of Geneva, Switzerland, promulgates ISO Standard 6780 that sets forth the standard dimensions for six sizes of pallet used in many countries. While six sizes may present a relatively limited degree of variation in the horizontal dimensions of pallets, this limited degree of variation is still known to have contributed to the occurrence of various accidents in the handling of palletized loads. More specifically, different sizes of pallets may require the lifting forks to extend further or not as far into the fork receiving locations of differently sized pallets to provide appropriate support for differently sized pallets during lifting, while avoiding extending forks further than necessary into the fork receiving locations such that the tips of the lifting forks do not extend so far as to protrude into contact with other objects.

FIGS. 1A through 1F depict various aspects of examples of prior art usage of lifting forks and pallets in materials handling. Starting with FIG. 1A, an elevational view is provided of a prior art example of a lifting vehicle 100 that may be employed to lift and move a palletized load 900 about. As depicted, the lifting vehicle 100 may include one or more of a motor 110, manually operable controls 120, a power source 130, wheels 170, a lilting mechanism 180 and one or more lifting forks 190 (only one of which is visible given the angle presented by the elevational view). As also depicted with an elevational view, the palletized load 900 may include one or more items 910 supported atop a pallet 990, and perhaps secured thereto by straps or other mechanism (not shown).

The motor 110 of the lifting vehicle 100 may be any of a variety of types of motor that is able to drive the wheels 170 to move the lifting vehicle 100 about and/or is able to drive the lifting mechanism 180 to lift the one or more lifting forks 190 along with one or more items supported thereby. Movement of the lifting vehicle 100 horizontally about and/or vertical movements of the lifting mechanism 180 may be controlled by an operator of the lifting vehicle 100 through operation of the controls 120. The power source 130 may be any of a variety of types of power source appropriate to provide power of a type useable by the motor 110, depending on the type of motor employed as the motor 110 (e.g., an electric motor, an internal combustion engine, a gas-turbine engine, etc.). The wheels 170 may be any of a variety of types of wheel appropriate to interact with the type of surface (not shown) atop which the lifting vehicle 100 is to be operated to lift and move palletized loads about. The lifting mechanism 180 may be any of a variety of types of lifting mechanism capable of causing vertical movement of the lifting forks 190 to lift palletized loads (e.g., electrically and/or hydraulically driven worm gear, hydraulic and/or pneumatic piston, etc.).

As depicted, each of the one or more lifting forks 190 may generally have a L-shape with a vertical portion 191 attachable to the lifting mechanism 180, and a horizontal portion 192 to support a pallet during lifting. One end of the horizontal portion 192 meets, and may be formed integrally with, the lower end of the vertical portion 191 at a right angle, thereby defining the L-shape. The other end of the horizontal portion 192 may taper in vertical thickness to a tip 193.

The pallet 990 may be fabricated from any of a wide variety of materials or combinations of materials, including and not limited to, wood, metal, plastic, fiberglass, compressed paper and/or cardboard. As is familiar to those skilled in the art, the exact design of the pallet 990 and/or the choice of material(s) from which the pallet 990 may be fabricated may be based, at least in part, on one or more characteristics of the items 910 expected to be supported atop the pallet 990. By way of example, where the items 910 include corrosive chemicals, the pallet 990 may be formed from a plastic or other material selected to be resistant to chemically interacting with such a chemical, and/or the pallet 990 may be designed with an integrated tub or basin to capture and retain an amount of such a chemical that may leak from a container to minimize the possible consequences thereof. Alternatively, by way of another example, and as depicted, the items 910 may not require such special handling considerations and may be contained in simple cardboard boxes such that the pallet 990 may be more simply constructed of wooden blocks and/or pieces of dimensional lumber.

Regardless of the exact nature of the construction of the pallet 990 and/or the materials from which the pallet 990 is formed, the pallet 990 may be structured to provide one or more fork receiving locations 992, each of which may be shaped and sized to permit the horizontal portion 192 of a lifting fork to be received therein. With the horizontal portion 192 of each of the one or more lifting forks 190 carried by the lifting vehicle 100 extending into a corresponding fork receiving location 992 of the pallet 990, the lifting mechanism 180 of the lifting vehicle 100 may be operated (e.g., via the controls 120) to vertically move the one or more lifting forks 190 in an upward direction to thereby lift the pallet 990, along with the items 910 supported atop the pallet 990.

FIG. 1B provides an elevational view, similar to FIG. 1A, depicting an example of operation of the lifting vehicle 100 to lift the pallet 990, as well as the items 910 supported thereon. As depicted, the lifting vehicle 100 has been moved to a position relative to the pallet 990 to position the horizontal portion 192 of each lifting fork 190 (again, only one lifting fork 190 is visible due to the angle presented in the elevational view) to extend into a corresponding fork receiving location 992 of the pallet 990. As also depicted, the positioning of the one or more lifting forks 190 carried by the lifting vehicle 100 is such that each of the lifting forks 190 extends just about far enough into the one or more corresponding fork receiving locations 992 of the pallet 990 to provide appropriate physical support to the pallet 990 during lifting, while not extending so far that the tip 193 of any of the one or more lifting forks 190 protrudes out of and beyond the pallet 990. Thus, the extending of the one or more lifting forks 190 of the lifting vehicle 100 into corresponding fork receiving locations 992 of the pallet 990 to such a depicted extent may be deemed more desirable than causing the one or more lifting forks 190 of the lifting vehicle 100 to extend into corresponding fork receiving locations 992 of the pallet 990 to either a lesser extent or a greater extent, as will now be explained.

Each of FIGS. 1C through 1E provides an elevational view, similar to FIGS. 1A and 1B, of an example of operation of the lifting vehicle 100 to at least attempt to lift the pallet 990, as well as the items 910 supported thereon, in a manner that could result in an accident in which injury to personnel, and/or damage to equipment and/or the items 910 may result. More specifically, each of FIGS. 1C through 1E depicts an example of positioning of the one or more lifting forks 190 of the lifting vehicle 100 (again, only one lifting fork 190 is visible due to the angle presented in each of these elevational views) relative to the pallet 990 that may be deemed undesirable to the extent of being deemed hazardous, along with a corresponding example of a type of accident that could result from such positioning.

Turning to FIG. 1C, the lifting vehicle 100 has been moved to a position relative to the pallet 990 such that the horizontal portions 192 of the one or more lifting forks 190 do not extend far enough into corresponding fork receiving locations 992 to provide appropriate physical support for the pallet 990 (and the items 910 supported thereon) during lifting thereof by the one or more lifting forks 190. As depicted, one possible result may be an accident in which structural failure of the pallet 990 causes spillage of at least some of the items 910 supported atop the pallet 990. However, as will be appreciated by those skilled in the art, another possible result (in lieu of such a structural failure) may be an accident in which both the pallet 990 and all of the items 910 supported thereon are tipped over causing the entirety of the palletized load 900 is spilled.

Turning to FIG. 1D, as depicted, the lifting vehicle 100 has been moved to a position relative to a pallet 990a of a palletized load 900a (one of multiple ones of the pallet 990 being shown) such that the horizontal portions 192 of the one or more lifting forks 190 are positioned to extend too far into corresponding fork receiving locations 992 such that the tips 193 of the one or more lifting forks 190 protrude beyond the pallet 990a. Unlike the situation depicted in FIG. 1C, the positioning of the one or more lifting forks 190 depicted in FIG. 1D may provide appropriate physical support for the pallet 990a, as well as the items 910 supported thereon of the palletized load 900a during lifting. However, as is shown, one possible result of this positioning may be that the tip 193 of each such lifting fork 190 extends partly into a receiving location 992 of another pallet 990b of another palletized load 900b that is located just beyond the palletized load 900a from the perspective of the lifting vehicle 100. With the palletized load 900a interposed between the lifting vehicle 100 and the other palletized load 900b, an operator of the lifting vehicle 100 may not be able to see the location of each such tip 193 relative to the other pallet 990b, and during subsequent lifting of the palletized load 900a, an accident may occur in which the other palletized load 900b may be tipped over.

FIG. 1E is similar to FIG. 1D, and depicts a similar instance of the horizontal portions 192 of the one or more lifting forks 190 extending too far into corresponding fork receiving locations 992 such that the tips 193 protrude beyond the pallet 990a of the palletized load 900a. However, unlike the situation shown in FIG. 1D, FIG. 1E depicts the palletized load 900a as being brought into the vicinity of another palletized load 900b by the lifting vehicle 100 in preparation for lowering the one or more lifting forks 190 of the lifting vehicle 100 to place the palletized load 900a in front of the other palletized load 900b (presuming that the palletized load 900a was successfully lifted elsewhere without incident before being brought into the vicinity of the other palletized load 900b). However, as is shown, one possible result from the protrusion of one or more of such lifting fork tips 193 beyond the pallet 990a (and which may occur as the palletized load 900a is brought into the vicinity of the palletized load 900b) may be an accident in which there is penetrating damage to one or more of the items 910 supported atop the other pallet 990b. Alternatively or additionally, as can readily be understood by those skilled in the art, another possible result may be an accident in which at least some of the items 910 supported atop the pallet 990b are tipped over, if not the entirety of the palletized load 900b.

FIG. 1F depicts an elevational view of a further circumstance that may increase the likelihood of the various types of accidents described in reference to FIGS. 1C through 1E, as well as others. More specifically and as depicted, the palletized loads 900a and 900b, as well as the corresponding ones of the pallets 990a and 990b, may be of different horizontal dimensions. As also depicted, this may impose a need for the lifting vehicle 100 to be capable of being used with multiple variants of the lifting forks 190, such as the depicted lifting forks 190a and 190b, in which the horizontal portions 192 thereof are of different horizontal lengths. Although many forklift operators may be trained in the tasks of switching between lifting forks of such different dimensions, and to remain mindful of the horizontal length of the particular lifting forks that may be currently installed on a lifting vehicle, it is not possible to entirely eliminate human error.

Various efforts have been made by others to address the potential for accidents arising from the positioning of lifting forks relative to fork receiving locations incorporated into pallets, and/or to address the additional potential for accidents arising from the use of lifting forks of differing dimensions. One solution has been to paint various markings onto portions of lifting forks that provide length measuring scales directly on surfaces of lifting forks. Unfortunately, it is not uncommon for surfaces of lifting forks to scrape against portions of pallets with sufficient force as to scrape off such paintwork. Also, in situations in which lifting forks are lifted to a relatively high height while stacking or unstacking palletized loads, such markings may cease to be visible to lifting vehicle operators.

### SUMMARY

The present invention addresses such needs and deficiencies as are explained above by providing a lifting fork positioning system to guide movement of a lifting vehicle to properly position one or more lifting forks thereof relative to a pallet to enable safe lifting thereof. The lifting fork positioning system may include a sensor device to be mounted adjacent to (and for movement with) the vertical portion of one or more lifting forks thereof to enable detection of a distance to a front face of a palletized load. The lifting fork positioning system may also include a console device to be mounted in the vicinity of manually operable controls of the lifting vehicle to present an operator thereof with an indication of the position of a front face of the palletized load relative to the one or more lifting forks. A processor component of the lifting fork positioning system may employ a received indication of a zero point distance to derive the indication of the position of a front face of the palletized load that is presented to the operator.

The sensor device may include a distance sensor that employs sound, light and/or any of a variety of other techniques to detect a distance to a front face of the palletized load. Where sound is employed, the distance sensor may include an ultrasonic transducer to emit ultrasound and/or receive emitted and reflected ultrasound as part of employing echo location to detect such a distance. Where light is employed, the distance sensor may include one or more solid state light emitting devices and/or lasers to project one or more beams of light and/or a pattern onto the front face of the palletized load. One or more photosensors and/or a camera element may be employed along with triangulation and/or various pattern analysis techniques to detect a distance to the front face of the palletized load based on the light reflected therefrom.

The console device may include a display to visually present the indication of the position of the front face of the palletized load relative to the one or more lifting forks. The displayed indication may be numeric indication of distance relative to a zero point distance. The numeric indication may be accompanied by a positive/negative value indication, and/or another form of indication to present a distinction between a distance relative to the zero point distance that extends further away from the vertical portion of the one or more lifting forks and a distance relative to the zero point distance that extends closer thereto.

The console device may include one or more manually operable controls to enable the location of the zero point distance to be provided to the lifting fork positioning system. The processor component may monitor the controls for instances of operation thereof to enter one or more commands, and the processor component may respond to the one or more commands in a manner that includes effecting one or more changes to the indications presented on the display. By way of example, the controls may include a button or other manually operable control to enter a command to clear a previously provided zero point distance. The processor component may respond to such an entered command by clearing or otherwise invalidating a stored indication of a previously provided zero point distance, and/or presenting on the display an indication of there currently being no zero point distance.

The processor component may cooperate with the distance sensor to set a zero point distance in response to operation of another button or other manually operable control to set a zero point distance. The processor component may respond to such an entered command by retrieving an indication of a distance currently detected by the distance detector to a portion of an object that currently faces the distance detector (e.g., the front face of a palletized load), storing that indication as the zero point distance, and/or presenting on the display an indication of a zero point distance currently being set.

Alternatively, the processor component may cooperate with one or more fork length detectors to determine the horizontal length of the horizontal portion of the one or more lifting forks, and then set the zero point distance based on the horizontal length. There may be a single fork length detector in the form of an optical scanning component to scan one or more surfaces of the horizontal portion of at least one of the one or more lifting forks to detect the horizontal length thereof. Alternatively, there may be one or more fork length detectors that may each be an optical scanning component to scan one or more surfaces of the vertical portion of at least one of the one or more lifting forks to read a bar code, alphanumeric character, and/or other indicia of the horizontal length thereof. As another alternative, there may be a single fork length detector in the form of a radio frequency identification (RFID) reader to read a wirelessly received indication of the horizontal length from a RFID tag device placed on at least one of the one or more lifting forks.

The sensor device and the console device may communicate via a wired or wireless coupling that extends therebetween. Such a wired coupling may include optical and/or electrical cabling that extends between the console and sensor devices to convey electric power and/or data therebetween. Such a wireless coupling may include exchanges of optical and/or radio frequency (RF) to convey data therebetween. The processor component and/or one or more other components coupled to the processor component may be disposed within a housing of either of the sensor device or the console device. Each of the sensor device and the console device may be provided with electric power from the lifting vehicle and/or from an internal power source, such as a battery.

### BRIEF DESCRIPTION OF THE DRAWINGS

A fuller understanding of what is disclosed in the present application may be had by referring to the description and claims that follow, taken in conjunction with the accompanying drawings, wherein:

FIGS. 1A, 1B, 1C, 1D, 1E and 1F are each elevational views of aspects of PRIOR ART operation of a lifting vehicle to lift a palletized load;

FIG. 2A is a perspective view of the lifting vehicle of FIGS. 1A-1F, now equipped with an example embodiment of a lifting fork positioning system to overcome shortcomings in the PRIOR ART, such as those depicted in FIGS. 1C-1E;

FIG. 2B is an elevational view of an example embodiment of positioning at least one lifting fork relative to components of one example of a pallet through use of the lifting fork positioning system of FIG. 2A;

FIG. 2C is an elevational view, similar to FIG. 2B, showing another example embodiment of positioning of at least one lifting fork relative to components of another example of a pallet through use of the lifting fork positioning system of FIG. 2A;

FIG. 2D is a perspective view of example embodiments of a console device and of a sensor device of the lifting fork positioning system of FIG. 2A;

FIG. 2E is an elevational view, similar to FIGS. 2B and 2C, of an example embodiment of automatic detection, by the sensor device of FIG. 2D, of a horizontal length of a horizontal portion of an example lifting fork;

FIG. 3A is a block diagram of an example embodiment of an internal architecture of the lifting fork positioning system of FIG. 2A;

FIG. 3B is a block diagram of another example embodiment of an internal architecture of the lifting fork positioning system of FIG. 2A;

FIG. 3C is a block diagram of an example embodiment of an internal architecture of a control routine of the internal architecture of either FIG. 3A or 3B;

FIG. 4A includes elevational views of embodiments of a console device of the lifting fork positioning system of FIG. 2A and of preparations for using the lifting fork positioning system with a lifting vehicle;

FIG. 4B includes elevational views of use of the lifting fork positioning system of FIG. 4A after performance of the preparations of FIG. 4A;

FIG. 4C includes elevational views, similar to FIG. 4B, of use of the lifting fork positioning system of FIG. 4A after performance of the preparations of FIG. 4A;

FIG. 5A includes elevational views, similar to FIG. 4A, of embodiments of a console device of the lifting fork positioning system of FIG. 2A and of alternate preparations for using the lifting fork positioning system with a lifting vehicle;

FIG. 5B includes elevational views, also similar to FIG. 4A, of alternate embodiments of a console device of the lifting fork positioning system of FIG. 2A and of preparations for using the lifting fork positioning system with a lifting vehicle;

FIG. 5C includes elevational views of use of the lifting fork positioning system of FIG. 5A or 5B after performance of the preparations of FIG. 5A or 5B; and

FIG. 5D includes elevational views, similar to FIG. 5C, of use of the lifting fork positioning system of FIG. 5A or 5B after performance of the preparations of FIG. 5A or 5B.

### DETAILED DESCRIPTION

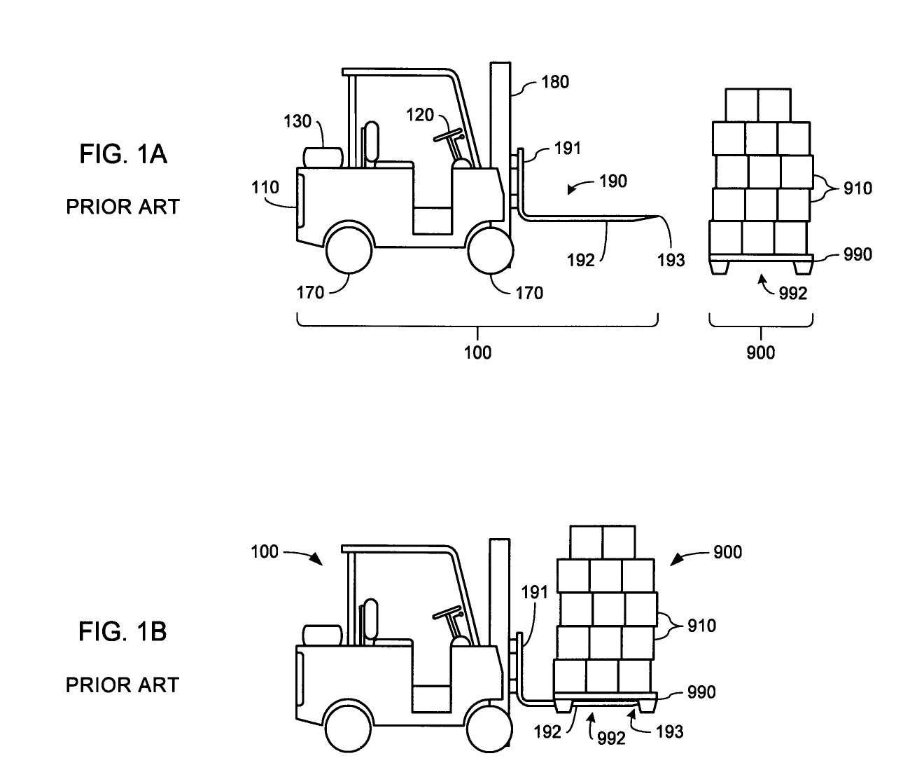

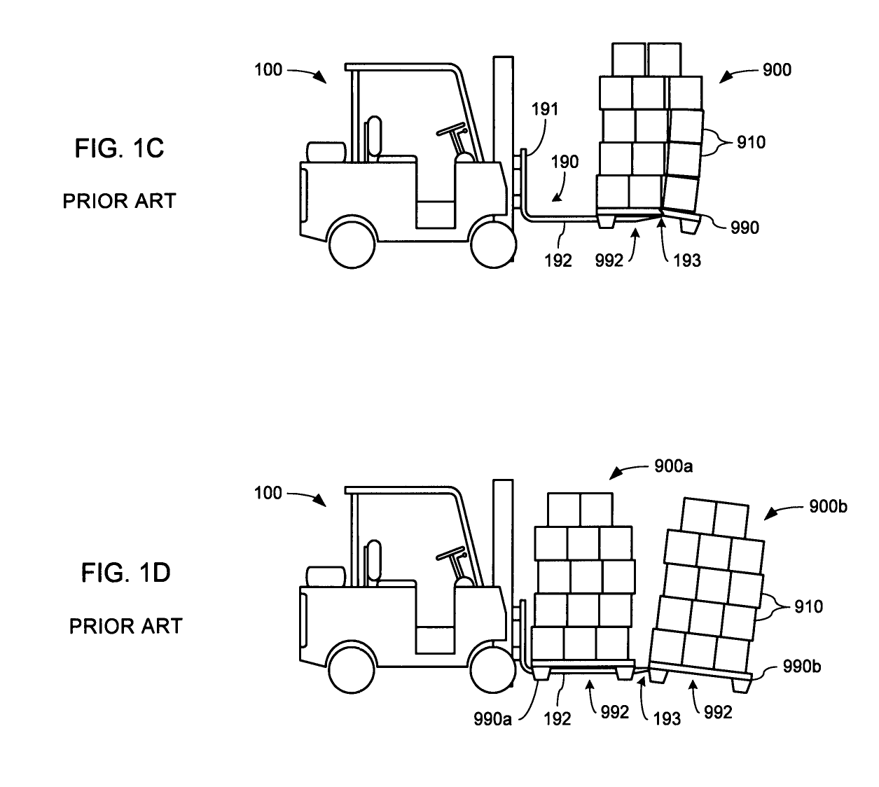

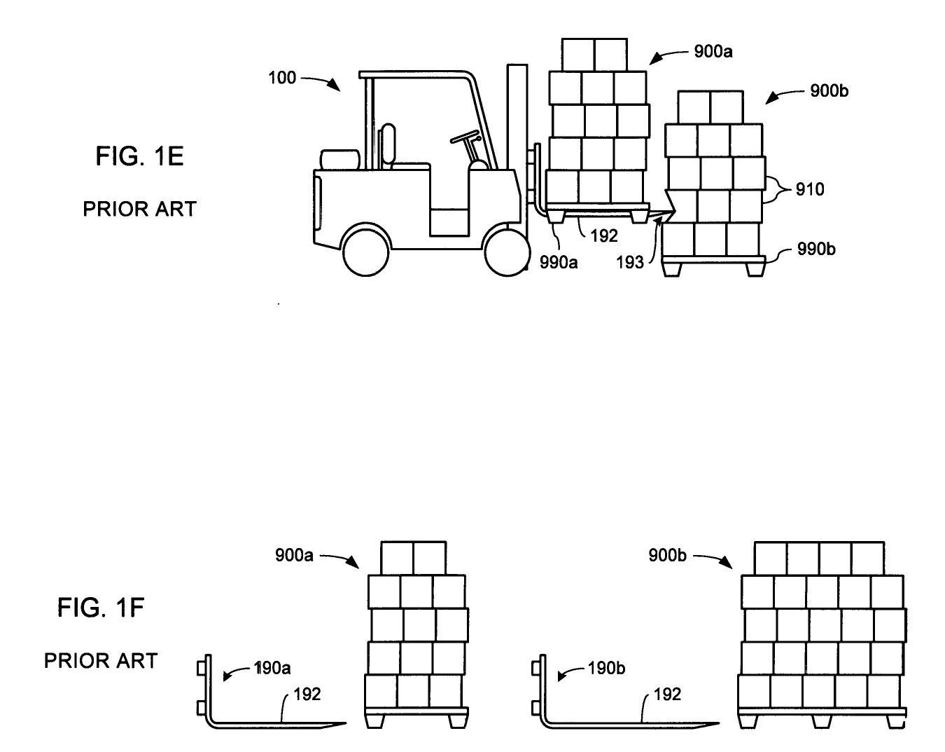

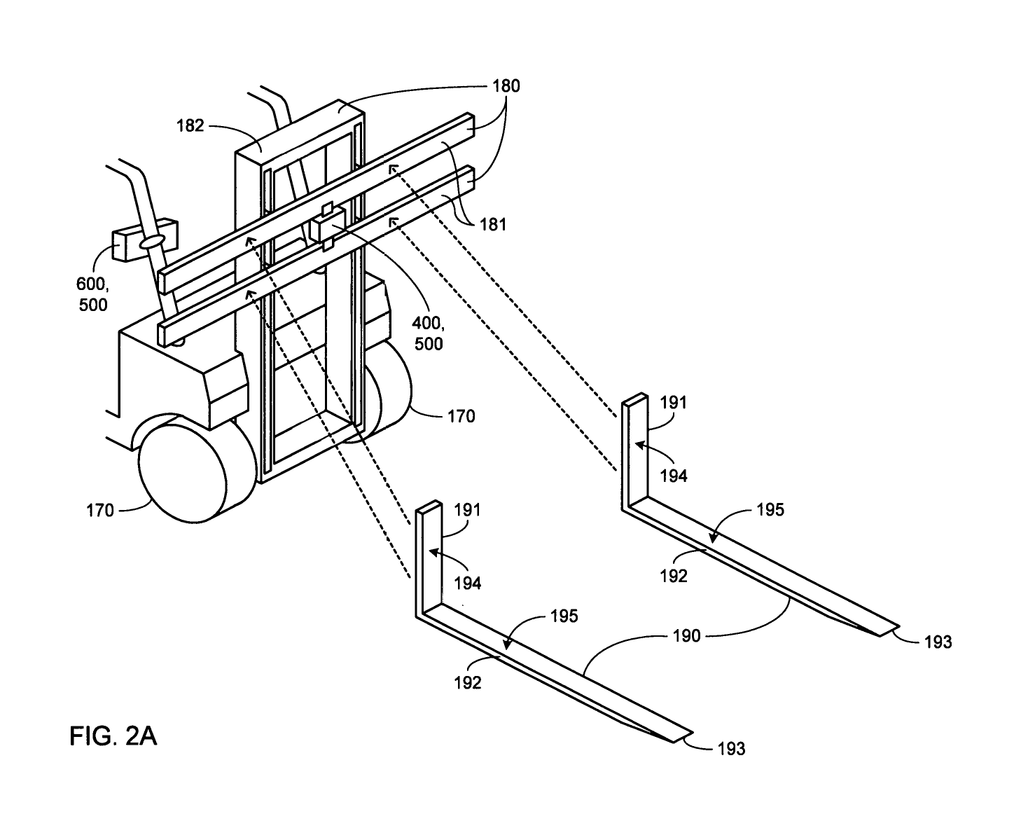

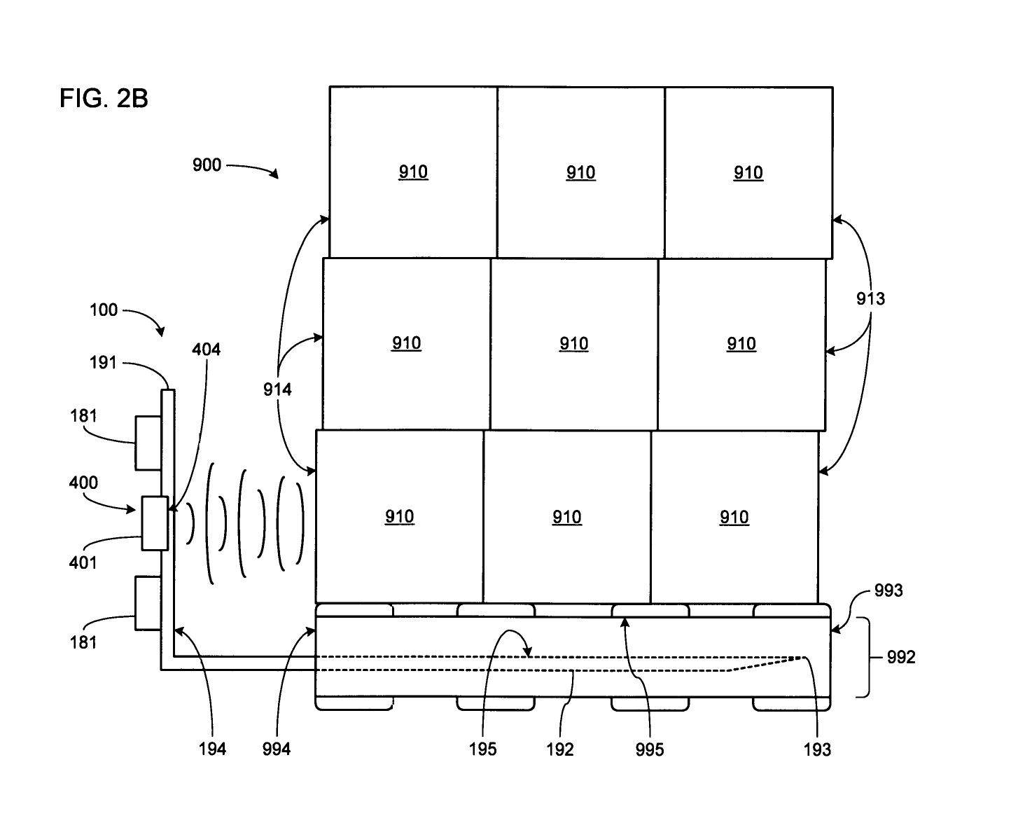

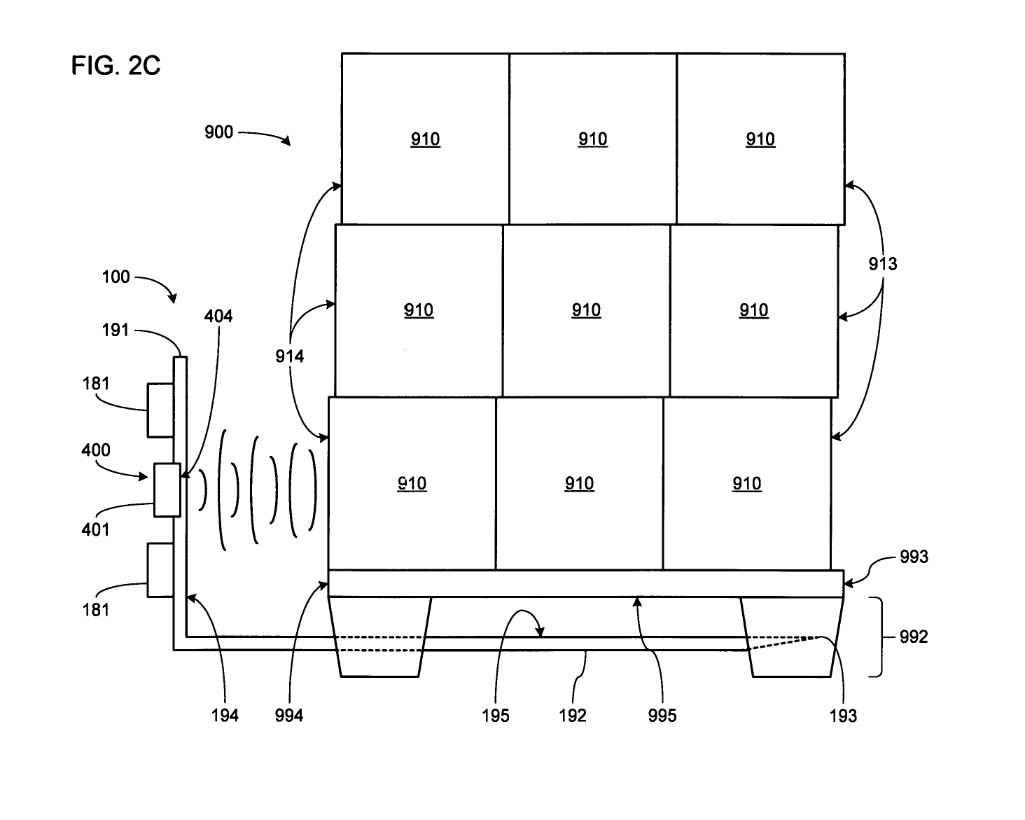

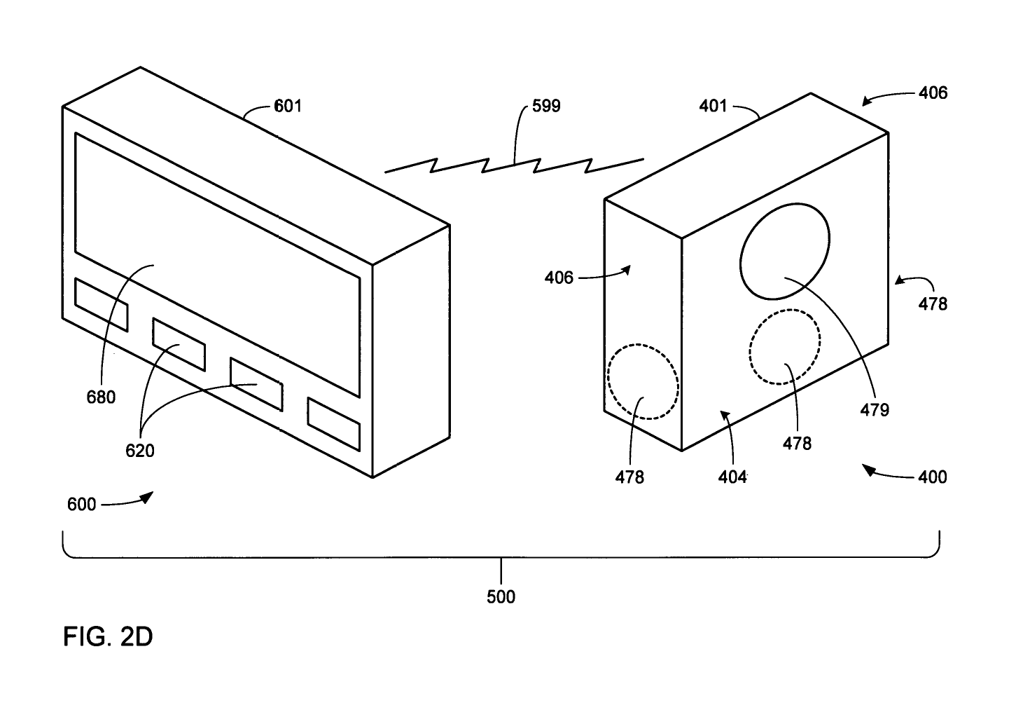

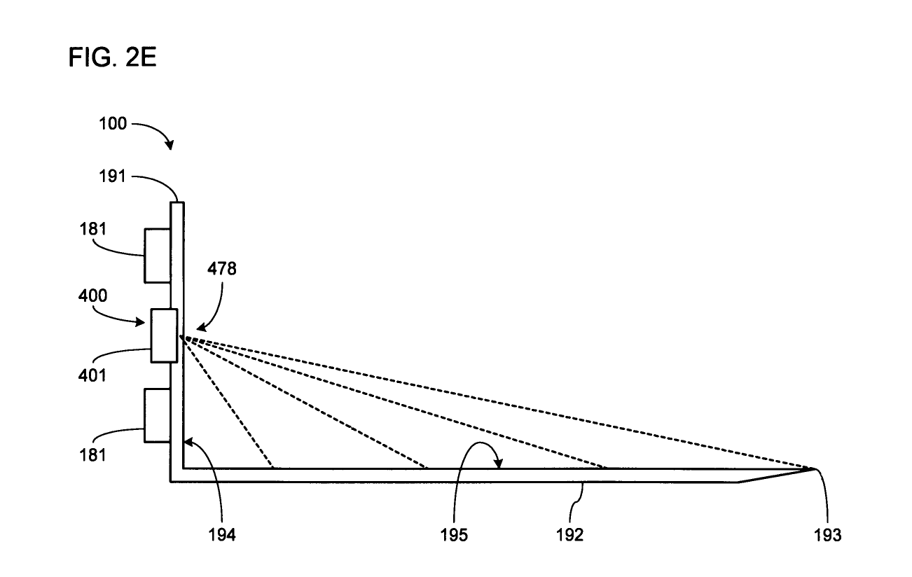

FIGS. 2A through 2D, taken together, depict various aspects of an example embodiment of a lifting fork positioning system 500 to improve aspects of operation of the example lifting vehicle 100 introduced in FIGS. 1A through 1F. Starting with FIG. 2A, a perspective view is provided of forward portions of the lifting vehicle 100, including the forward-most pair of the wheels 170, the lifting mechanism 180, and at least one pair of the lifting forks 190. A console device 600 of the lifting fork positioning system 500 may be mounted to a forward portion of the body of the lifting vehicle 100 to visually present indications of the position of a pallet 990 relative to one or more of the lifting forks 190. As also depicted, the lifting mechanism 180 includes a lifting frame 182 mounted onto forward portions of the body of the lifting vehicle 100, and a pair of lifting crossbars 181 connected to, and vertically movable concurrently along the vertical extent of the lifting frame 182. A sensor device 400 of the lifting fork positioning system 500 may be mounted on one or both of the lifting crossbars 181 to detect a distance to a palletized load 900.

As is also shown, the pair of lifting forks 190 are able to be removably mounted to the pair of lifting crossbars 181, thereby enabling the lilting forks 190 to be moved with the lifting crossbars 181 along vertically extending portions of the lifting frame 182. As previously discussed in reference to FIG. 1F, the ability to detach each lifting fork 190 may make possible its replacement with another lifting fork 190 of different dimensions to better accommodate different pallets 990 of different sizes. As familiar to those skilled in the art, the pair of lifting crossbars 181 and/or each of the lifting forks 190 may be configured to enable each of the lifting forks 190 to be mounted at any of multiple locations along the horizontally extending length of the pair of lifting crossbars 181 to afford some degree of flexibility in configuring the lifting vehicle 100 for use.

FIGS. 2B and 2C each provide an elevational view of an example embodiment of using the lifting fork positioning system 500 to position at least one lifting fork 190 relative to components of an example of the pallet 990 in preparation for lifting an example of the palletized load 900. FIG. 2B depicts an example embodiment of positioning at least one lifting fork 190 relative to the dimensional lumber components of a widely used type of the pallet 990 made from wood. FIG. 2C depicts an example embodiment of positioning at least one lifting fork 190 relative to the depending leg components of another widely used type of the pallet 990 (sometimes referred to as a “skid”) made from molded plastic.

Referring to FIGS. 2A through 2C, and as previously discussed, each lifting fork 190 may include an elongate vertical portion 191, an elongate horizontal portion 192 that meets at one end with an end of the vertical portion 191 at a right angle, and a tip 193 at the other end of the horizontal portion 192. The vertical portion 191 may be shaped and oriented in a manner that defines an elongate vertical surface 194 that may be substantially flat and that may face generally forwardly from the lifting vehicle 100 when one of the lifting forks 190 is mounted on the lifting crossbars 181. Thus, with one of the lifting forks 190 mounted on the pair of lifting crossbars 181 and positioned by the lifting vehicle 100 relative to the pallet 990 as depicted in either of FIG. 2B or 2C, the vertical surface 194 of that lifting fork 190 may face both a front face 914 of the one or more items 910 of the palletized load 900 and a front face 994 of the pallet 990, while a rear face 913 of the one or more items 910 of the palletized load 900 and a rear face 993 of the pallet 990 may both face away from the vertical surface 194.

As familiar to those skilled in the art, the provision of the relatively flat vertical surface 194 on the vertical portion 191 each lifting fork 190 is to address situations in which a lifting fork 190 is positioned relative to the palletized load 900 such that the front faces 914 and/or 994 become close enough to the lifting vehicle 100 to make contact with forward portions thereof. Stated differently, the vertical surface 194 is positioned further forward than most other components of the lifting vehicle 100 to prevent the front face 914 of the items of the palletized load 900 and/or the front face 994 of the pallet 990 from coming into contact with those other components, which might lead to damage to the lifting vehicle 100 and/or to one or more of the items 910 of the palletized load 900. In part, due to this function served by the vertical surface 194, the vertical portion 191 is sometimes referred to as “the back” of a lifting fork 190.

Each horizontal portion 192 of each lifting fork 190 may be shaped in a manner that defines a substantially flat, horizontally-extending and upwardly-facing support surface 195 that is intended to engage a corresponding horizontally-extending and downwardly facing support surface 995 of either of the example pallets 990 of FIGS. 2B and 2C. This engagement between the support surfaces 195 and 995 provides physical support to the pallet 990 during a lift by the lifting vehicle 100. The support surface 195 may be a single and continuous flat surface extending within a single horizontal plane across substantially all of the horizontal portion 192, including the forward-most end of the horizontal portion 192 where the vertical thickness of the horizontal portion 192 is reduced to define the tip 193.

FIG. 2D provides perspective views of example embodiments of both the sensor device 400 and the console device 600. As depicted, the sensor device 400 and the console device 600 may communicate to exchange data therebetween via any of a variety of types of wireless communication (including line-of-sight optical, radio frequency transmissions, etc.) by which a wireless link 599 may be formed and/or maintained therebetween. Alternatively, and although not shown, optically and/or electrically conductive cabling may extend between and may couple the sensor device 400 and the console device 600 to each other to provide wired communications to exchange at least data therebetween, if not also electric power. The use of wireless communications between the sensor device 400 and the console device 600, however, may be deemed more desirable than the use of wired communications through cabling extending therebetween, since such cabling may become caught among moving components of the lifting vehicle 100, such as moving components associated with one or more of the wheels 170 and/or moving components associated with the lifting mechanism 180.

The sensor device 400 may incorporate a casing 401 within which the sensor device 400 may carry a distance sensor 479 in a manner that causes the distance sensor 479 to be oriented to face generally forwardly from the lifting vehicle 100 when the sensor device 400 is mounted to one or both of the lifting crossbars 181, as exemplified in FIG. 2A. The mounting of the sensor device 400 to one or both of the lifting crossbars 181 (or another portion of the lifting mechanism 180 that moves vertically with the one or more lifting forks 190) causes the sensor device 400 to also move vertically with the one or more lifting forks 190. Thus, with the sensor device 400 so mounted, the distance sensor 479 is able to detect a distance to the palletized load 900 as the lifting vehicle 100 is moved to position the one or more lifting forks 190 relative to the pallet 990 thereof, regardless of whether the palletized load 900 sits atop the same flooring surface as the wheels 170 of the lifting vehicle 100, or is supported at a higher elevation, such as atop another palletized load or atop a shelf.

The casing 401 of the sensor device 400 may be of a shape and/or size that defines a forward face 404 that faces generally forwardly from the lifting vehicle 100 when the sensor device 400 is mounted to one or both of the lifting crossbars 181. Indeed, the distance sensor 479 may be incorporated into and/or otherwise carried by the forward face 404 to cause the distance sensor 479 to be oriented to face generally forwardly, as has been described.

Referring briefly to FIGS. 2B and 2C, as well as to FIG. 2D, the casing 401 may be mounted in any of a variety of ways to one or both of the lifting crossbars 181 (depicted end-on in the elevational views of FIGS. 2B and 2C), including in a manner in which the casing 401 is suspended between and/or otherwise among the lifting crossbars 181 to ensure that the forward face 404 of the casing 401 does not extend farther forward from the body of the lifting vehicle 100 than does the vertical surface 194 of each of the one or more lifting forks 190 that may also be mounted on the pair of lifting crossbars 181. Indeed, as depicted, the forward face 404 of the casing 401 may be recessed somewhat rearwardly closer to the body of lifting vehicle 100 relative to the vertical surface 194 of each of such mounted lifting forks 190.

Continuing with FIGS. 2B and 2C, as well as FIG. 2D, such positioning of the casing 401 of the sensor device 400 may be deemed desirable to allow the vertical surface 194 of each of the one or more lifting forks 190 that may be mounted to the pair of lifting crossbars 181 to provide the same earlier discussed protection to the sensor device 400 as to other components of the lifting vehicle 100 from instances of portions of the front faces 914 and/or 994 of the palletized load 900 becoming too close to forward portions of the lifting vehicle such that damage thereto may be caused by contact with the front faces 914 and/or 994. Again, it may be deemed desirable to cause the front faces 914 and/or 994 to come into contact with one or more of such vertical surfaces 194, rather than to be allowed to come into contact with other forward components of the lifting vehicle 100, as well as into contact with a portion of the sensor device 400.

Returning to FIG. 2D, in various embodiments, the sensor device 400 may also incorporate one or more fork length detectors 478 to detect the horizontal length of one or more lifting forks 190 mounted to the lifting crossbars 181. In some embodiments, the sensor device 400 may incorporate a single fork length detector 478 implemented as an optical scanning component to scan the support surface 195 of one or more lifting forks 190 mounted to the lifting crossbars 181 to detect the horizontal length(s) thereof. In such embodiments, the single fork length detector 478 may be incorporated into and/or otherwise carried by the forward face 404 of the casing 401 along with the distance sensor 479. In this way, the single fork length detector 478 may be properly positioned relative to the support surface 195 of one or more of such mounted lifting forks 190 to perform an optical scan thereof, as depicted in FIG. 2E.

Again returning to FIG. 2D, in other embodiments, the sensor device 400 may incorporate one or more fork length detectors 478 that are each implemented as an optical scanning component to each scan one or more other surfaces of one or more lifting forks 190 mounted on the lifting crossbars 181 for an indicia (e.g., an indicia on a sticker, a painted-on indicia, a printed-on indicia, an engraved indicia, etc.) of the horizontal length thereof. In such embodiments, the casing 401 of the sensor device 400 may be of a shape and/or size that defines one or more side faces 406 that each face generally sideways relative to the forward face 404 when the sensor device 400 is mounted to one or both of the lifting crossbars 181. One or more of such side faces 406 may each incorporate one of the one or more fork length detectors 478 to cause that one of the one or more fork length detectors 478 to scan sideways towards a surface of the vertical portion 191 of one of such mounted lifting forks 190 where an indicia of its horizontal length may be located on that surface. To avoid instances of such indicia being scraped off a lifting fork 190 as a result of frequent physical contact with components of numerous pallet 990 and/or items 910 of numerous palletized loads 900, the lifting fork 190 may carry such indicia on a surface of the vertical portion 191 that faces sideways relative to the vertical surface 194, and towards the sensor device 400.

In still other embodiments, the sensor device 400 may incorporate a single fork length detector 478 implemented as a RFID reader to electromagnetically transmit electric power to, and then receive a wirelessly transmitted indication of the horizontal length from, a RFID tag device adhered to, or otherwise affixed to and/or incorporated into, each of one or more lifting forks 190 mounted on the lifting crossbars 181. As familiar to those skilled in the art, there can be a degree of directionality to RFID communications in which RFID tags located within a certain subset of directions from a pickup coil or antenna of a RFID reader are more easily energized with electromagnetically supplied electricity and/or wirelessly communicated with. In recognition of this, such a fork length detector 478 may be oriented within the casing 401 to take into account where a RFID tag carried by a lifting fork 190 is expected to be located relative to the casing 401 of the sensor device 400 when that lifting fork 190 is mounted to the lifting crossbars 181. To avoid instances of such a RFID tag being damaged and/or removed from a lifting fork 190 as a result of frequent physical contact with components of numerous pallet 990 and/or items 910 of numerous palletized loads 900, the lifting fork 190 may carry a RFID tag on a surface of the vertical portion 191 other than the vertical surface 194.

As also depicted in FIG. 2D, the console device 600 may carry one or more manually operable controls 620 and/or a display 680 within a casing 601 in a manner that contributes to providing an operator of the lifting vehicle 100 with a user interface by which the operator interacts with the lifting fork positioning system 500. The display 680 may use alphanumeric characters and/or other forms of visual indicators to visually present distances, whether a zero point distance has been set and/or reset, one or more warnings, and/or one or more indications of the operational status of the lifting fork positioning system 500. The controls 620 may include one or more manually operable control components (e.g., buttons, paddle switches, rocker switches, rotary dials, joysticks, touchpads, electrostatic proximity sensing switches, etc.) by which an operator may turn the lifting fork positioning system 500 on or off, set and/or clear a zero point distance, trigger detection of the horizontal length of one or more lifting forks 190, etc. However, in alternate embodiments, the display 680 may be a touch-sensitive display on which the equivalent of such manually operable controls may be visually presented as specifically designated touch-sensitive regions within the display area of the display 680, thereby obviating the need to include one or more of the manually operable controls 620 that may otherwise be needed to receive operator input.

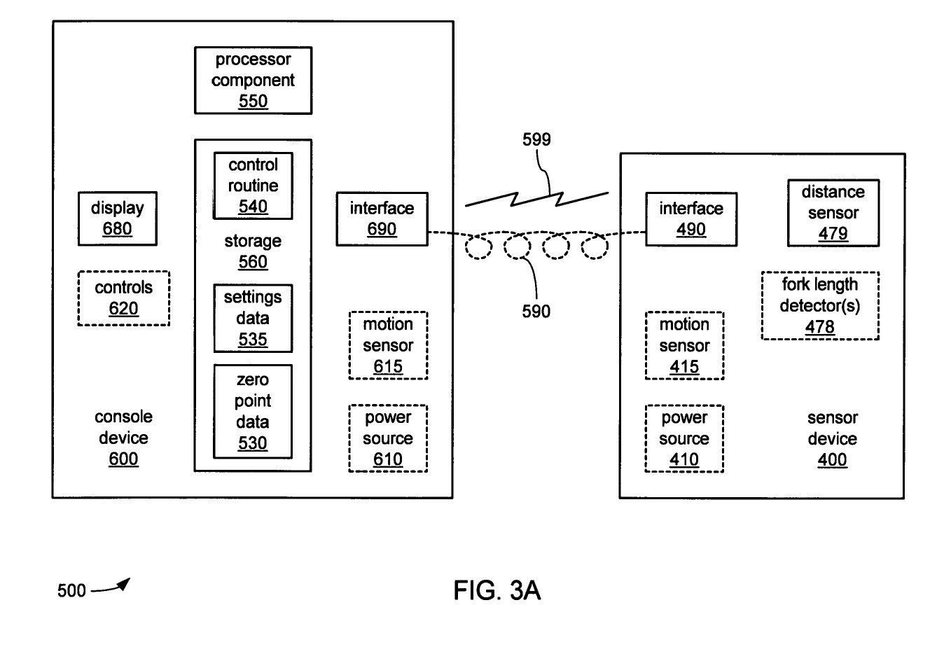

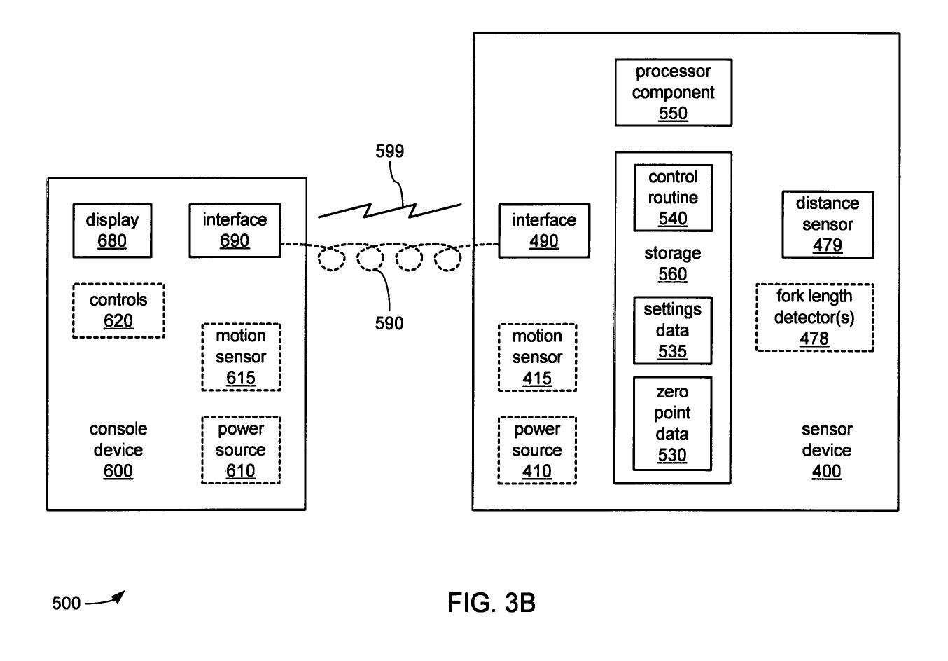

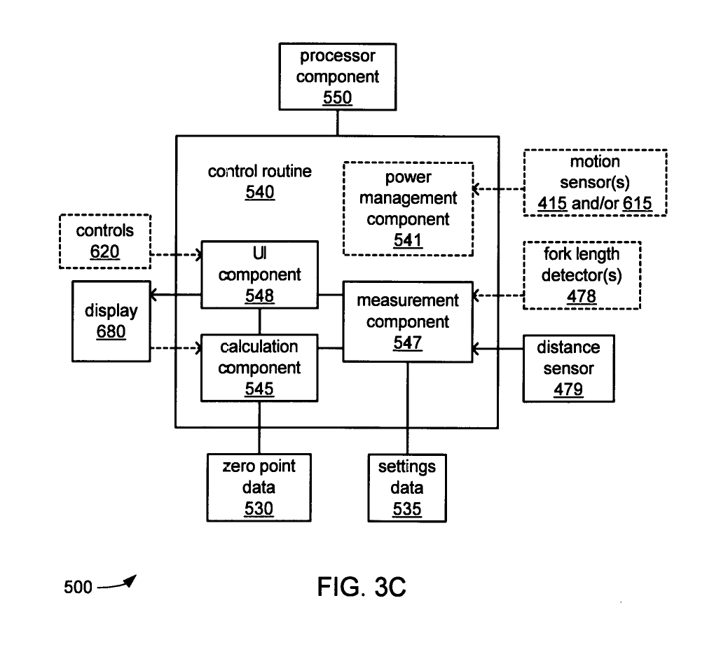

FIGS. 3A through 3C, taken together, depict various internal aspects of the lifting fork positioning system 500. FIGS. 3A and 3B each provide a block diagram of embodiments of the sensor device 400 and the console device 600. FIG. 3C provides a block diagram of an example operating environment and operation of a processor component 550 of the lifting fork positioning system 500.

Turning to both FIGS. 3A and 3B, the sensor device 400 may include a power source 410, a motion sensor 415, one or more fork length detectors 478, a distance sensor 479, and/or an interface 490. The console device 600 may include a power source 610, a motion sensor 615, manually operable controls 620, a display 680, and/or an interface 690. As can be appreciated by a comparison of FIGS. 3A and 3B, in different embodiments, either the sensor device 400 or the console device 600 may also include a the processor component 550 and a storage 560. The storage 560 may store one or more of a control routine 540, a settings data 535 and a zero point data 530. In embodiments in which the processor component 550 is located within the console device 600 (e.g., as depicted in FIG. 3A), the processor component 550 may monitor and/or operate one or more of the power source 410, the motion sensor 415, the one or more fork length detectors 478 and the distance sensor 479 through the interfaces 690 and 490. Correspondingly, in embodiments in which the processor component 550 is located within the sensor device 400 (e.g., as depicted in FIG. 3B), the processor component 550 may monitor and/or operate one or more of the power source 610, the motion sensor 615, the controls 620 and the display 680 through the interfaces 690 and 490.

The control routine 540 may include a sequence of instructions to implement logic to perform one or more functions. The processor component 550 may be coupled to the storage 560 and may access the control routine 540 within the storage 560 to execute the control routine 540, thereby causing the processor component 550 to perform one or more of those various functions. The processor component 550 may be any of a variety of commercially available processors, employing any of a variety of processing technologies and implemented with one or more cores physically and electrically combined in any of a number of ways. The storage 560 may be made up of one or more distinct storage devices that each may be based on any of a wide variety of storage technologies of volatile and/or non-volatile nature.

The sensor device 400 and the console device 600 may be wirelessly coupled via the wireless link 599 to enable communications therebetween in which data may be exchanged. Alternatively or additionally, the sensor device 400 and the console device 600 may coupled by an optically and/or electrically conductive cable 590 to enable at least communications therebetween in which data may be exchanged. Each of the interfaces 490 and 690 may be based on any of a variety of wireless and/or cable-based communications technologies for use in exchanging data between the devices 400 and 600, depending at least in part, on whether the devices 400 and 600 are coupled wireless (e.g., via the wireless link 599) or via cabling (e.g., the cable 590).

In some embodiments, electric power may be received by either or both of the devices 400 and 600 from the lifting vehicle 100. For example, electric power may be received from the motor 110 where the motor 110 produces electricity, and/or from the power source 130 where the power source 130 is a battery or other component (or set of components) that stores an electric charge. In other embodiments, electric power may be internally provided to one or both of the devices 400 and 600. For example, each of the power sources 410 and/or 610 (if either or both are present in various embodiments) may be a battery, solar cell, and/or other component that enables electric power to be generated and/or stored within either or both of the devices 400 and 600. Regardless of the manner in which electric power is provided to one of the devices 400 and 600, in embodiments in which the devices 400 and 600 are coupled by the cable 590, the cable 590 may convey electric power from one of the devices 400 and 600 to the other.

Each of the motion sensors 415 and 615 (if either or both are present in various embodiments) may be based on any of a variety of technologies for detecting movement of respective ones of the sensor device 400 and the console device 600, including and not limited to, microelectromechanical systems (MEMS) technology. In some embodiments, it may be that only one of the motion sensors 415 and 615 is present, and only within the one of the devices 400 and 600 that incorporates the processor component 550 (e.g., as in one of the depicted example embodiments of either FIG. 3A or 3B). In executing the control routine 540, the processor component 550 may recurringly monitor at least one of the motion sensors 415 and 615 to determine, through the detection of movement, whether the lifting vehicle 100 is currently in use.

As previously discussed, each of the devices 400 and 600 may be mounted on a portion of the lifting vehicle 100. As a result, such movement of the lifting vehicle 100 as might occur during normal operation of the lifting vehicle 100 to lift and/or move about palletized loads 900 may be detected by one or both of the motion sensors 415 and 615 as movement of the devices 400 and 600, respectively. If the processor component 550 determines that a predetermined period of time has passed since such movement was last detected by the motion sensor 415 and/or the motion sensor 615, the processor component 550 may determine that the lifting vehicle is no longer in use. In response to such a determination, the processor component may act to conserve electric power provided by the lifting vehicle 100 and/or one or both of the power sources 410 and 610 by turning off the sensor device 400 and the console device 600, thereby turning off the lifting fork positioning system 500. Alternatively or additionally, at a time when the lifting fork positioning system 500 is turned off, the processor component 550 may periodically consume a relatively small amount of electric power to monitor one or both of the motion sensors 415 and 615 for indications of movement deemed indicative of use of the lifting vehicle 100 having begun. In response to such an indication, the processor component 550 may determine that the lifting vehicle 100 is now in use, and may turn the sensor device 400 and the console device 600 on.

As previously discussed, the distance sensor 479 may employ any of a variety of technologies to detect a distance from the location of the distance sensor 479 to a surface of an object, such as the front face 914 provided by one or more items 910 of a palletized load 900 and/or the front face 994 provided by a pallet 990 of a palletized load. Again, such technologies include, and are not limited to, detection of emitted and reflected ultrasound followed by a timing analysis in a form of echo location, and/or detection and analysis of emitted and reflected laser light or projected pattern of light followed by triangulation and/or other form of analysis.

In executing the control routine 540, the processor component 550 may recurringly monitor the distance sensor 479 for indications of a currently detected distance from the distance sensor 479 to an object. In some embodiments, the processor component may impose a minimum threshold of time that must elapse while multiple indications of a distance are received before that distance is accepted as a correctly detected distance. In so doing, the processor component may allow for up to a maximum threshold of degree of variation in the detected distance during that minimum threshold of time. The imposition of such a threshold may be deemed desirable to guard against the acceptance and use of spurious readings that may be caused by events and/or situations in the environment surrounding the lifting vehicle 100, such as a person momentarily walking in front of the distance sensor 479.

As also previously discussed, each of the fork length detectors 478 (if any are present in various embodiments) may employ any of a variety of technologies to determine the horizontal length of the support surface 195 of one or more lifting forks 190. Again, such technologies include, and are not limited to, detection and analysis of emitted and reflected laser light or projected pattern of light followed by triangulation and/or other form of analysis, scanning and interpreting an indicia, and/or reception of a wireless RF signal from a RFID tag energized through electromagnetic transmission of electric power thereto.

In some embodiments, in executing the control routine 540, the processor component 550 may operate the one or more fork length detectors 478 in response to the receipt of a command to determine the horizontal length of the support surface 195 of one or more lifting forks 190. Such a command may be received from operation of a manually operable control 620 by an operator of the lifting vehicle 100. Alternatively or additionally, the processor component 550 may so operate the one or more fork length detectors 478 on a recurring basis, such as on a repeating interval of time, or in response to an indication of movement detected by one or both of the motion sensors 415 and 615 (if either are present in various embodiments).

It should be noted that, in some embodiments where similar technologies are used, the distance sensor 479 may be combined with at least one fork length detector 478, or may be employed to serve both of the purposes of determining a horizontal length of the support surface 195 of a lifting fork 190 and detecting the distance to the front face(s) 914 and/or 994 of a palletized load 900. Alternatively or additionally, in some embodiments where similar technologies are used, the interface 490 and/or the interface 690 may be used to additionally receive the RF signal conveying an indication of a horizontal length transmitted by a RFID tag affixed or otherwise incorporated into a lifting fork 190. However, an additional transmission circuit and/or antenna may be required to electromagnetically transmit electrical power to the RFID tag to enable the RFID tag to transmit the RF signal conveying the indication of the horizontal length.

The display 680 may be based on any of a variety of display technologies, including and not limited to, liquid crystal display (LCD), plasma, electroluminescent (EL), arrays of discrete lighting-emitting diodes (LEDs), one or more sets of LEDs configured to visually present individual alphanumeric characters (e.g., so-called 7-segment or 16-segment display units), etc. As previously discussed, each of the one or more manually operable controls 620 may be implemented using any of a variety of switches, sets of switches (e.g., keypads or keyboards), touch sensors, proximity sensors, etc. However, as also previously discussed, the display 680 may be a touch-sensitive display (e.g., a touch screen combining a display with touch sensing components), thereby enabling some or all of the controls 620 to be replaced by the designation of one or portions of the displayable area of the display 680 as “soft buttons” or other graphically generated “controls” that may be operated by touch.

In executing the control routine 540, the processor component 550 may recurringly monitor the controls 620 for indications of manual operation thereof to provide operator input. Alternatively or additionally, in embodiments in which the display 680 is touch-sensitive such that the display 680 is able to function as a touchscreen, the processor component 550 may recurringly monitor the touch-sensitive components of the display 680 for such indications of operator input in addition to or in lieu of monitoring the controls 620. In various embodiments, the processor component 550 may operate the display 680 to provide visual indications of the current status of the lifting fork positioning system 500, including and not limited to, visual indications of whether a zero point distance has been set, what the zero point distance is, a horizontal length distance of the support surface 195 of the horizontal portion 192 of a lifting fork 190, a length measurement of how close the tip 193 of a lifting fork 190 is to front faces 914 and/or 994 of a packetized load 900, a length measurement indicative of how close a tip 193 of a lifting fork 190 is to being properly positioned within a fork receiving location 992 of a pallet, etc.

In some embodiments, the processor component 550 may operate the display 680 and controls 620, or a touch-sensitive implementation of the display 680 to provide a user interface to an operator of the lifting vehicle 100 that enables the operator to set one or more parameters for the operation of the lifting fork positioning system 500. Such parameters may include, and are not limited to, a choice of measurement system for indicating lengths on the display 680 (e.g., inches or centimeters), a minimum and/or a maximum distance expected to be encountered between the front face 994 and the rear face 993 of a pallet 990 (corresponding to the smallest and/or largest sized pallets 990 expected to be encountered), a minimum threshold of time during which a distance must continue to be detected by the distance sensor 479 to be accepted as a correct indication of a current distance, a maximum threshold of variation in the indications of distance detected during the minimum threshold for a distance that continues to be detected during the minimum threshold of time to be accepted as the current distance, etc.

In some embodiments, the processor component 550 may operate the display 680 to provide various warnings of conditions that may adversely affect operation of the lifting fork positioning system 500. Such conditions may include, and are not limited to, impending loss of electric power to one or both of the sensor device 400 and the console device 600, an instance of the horizontal portion 192 of a lifting fork 190 not having been extended far enough into a fork reception location 992 of a pallet 990 to enable the support surface 195 of the horizontal portion 192 to provide sufficient support during lifting of the pallet 990, an instance of the horizontal portion 192 of a lifting fork 190 having been extended too far into a fork reception location 992 of a pallet 990 such that the tip thereof 193 is extending beyond the rear face 993 of the pallet 990.

Turning to FIG. 3C, as depicted, the control routine 540 may incorporate one or more of power management component 541, a calculation component 545, a measurement component 547 and user interface (UI) component 548. Each of the components 541, 545, 547 and 548 may include instructions executable by the processor component 550 to implement logic to perform various functions.

In executing the power management component 541 (if present in various embodiments), the processor component 550 may be caused to recurringly monitor one or both of the motion sensors 415 and 615 (if either are present in various embodiments) for indications of movement consistent with normal operation of the lifting vehicle 100 to lift and/or move about palletized loads 900. In some embodiments, if a predetermined amount of time elapses since the last instance of detecting such movement, the processor component 550 may respond by turning off the lifting fork positioning system 500 to conserve electric power. Alternatively or additionally, if such movement is detected at a time when the lifting fork positioning system 500 is turned off, the processor component 550 may respond by turning on the lifting fork positioning system 500.

In executing the measurement component 547, the processor component 550 may be caused to recurringly operate the distance sensor 479 to recurringly attempt to detect a distance between the distance sensor 479 and an object, if that object is within range of the distance sensor 479. In some embodiments in which one or more fork length detectors 478 are present, the processor component 550 may be caused to operate the one or more fork length detectors 478 to detect a horizontal length of the support surface 195 provided by at least one lifting fork 190. In some embodiments, the processor component 550 do so in response to the detection of movement via one or both of the motion sensors 415 and 615 after a the passage of a predetermined extended period of time in which no movement has been detected. This may be deemed desirable in response to a possibility that one lifting fork 190 may have been switched for another of different horizontal length while there was no movement detected.

In executing the UI component 548, the processor component 550 may recurringly monitor the manually operable controls 620 and/or touch-sensitive components of the display 680 (in embodiments in which the display 680 is touch-sensitive) for indications of operator input. The processor component 550 may operate the display 680 and/or the controls 620 to provide a user interface that presents visual indications of status of the lifting fork positioning system 500 and allows the operator of the lifting vehicle 100 to enter one or more parameters which the processor component 550 may store as part of the settings data 535.

The processor component 550 may also operate the display 680 and/or the controls 620 to allow the operator to trigger use of the distance sensor 479 and/or one or more fork length detectors 478 (if one or more are present in various embodiments) to set a zero point distance. By way of example, in an embodiment in which there are no fork length detectors 478, in response to no zero point distance having been set, the processor component 550 may operate the display 680 to provide a visual prompt to an operator to set a zero point distance. The processor component 550 may await the completion of actions by the operator to position at least one lifting fork 190 relative to a palletized load 990 or other object that presents a vertical surface able to be detected by the distance sensor 479. With the at least one lifting fork 190 so positioned by the operator, the operator may then operate a control 620 and/or touch a portion of the display 680 to input a command to set the zero point distance. In response to this input of this command, the processor component may operate the distance sensor 479 to measure the distance to the palletized load 990 or whatever other object presenting a vertical surface that the operator has positioned the at least one lifting fork 190 relative to. The processor component 550 may then store an indication of that measured distance as the zero point data 530.

As will be explained, in some embodiments, the operator may position the at least one lifting fork 190 relative to a palletized load 900 or another object providing a detectable vertical surface to set a zero point distance that coincides with the length of the support surface 195 of the horizontal portion 192 of that lifting fork 190. In so doing, the operator may leave a relatively small distance or “cushion” distance between the tip 193 of that lifting fork 190 and that palletized load 900 or object. Such a distance may be 1 to 2 inches (or 5 to 10 centimeters) as per a policy in which correct positioning of the support surface 195 of a lifting fork relative to a fork receiving location 992 of a pallet 990 is 1 to 2 inches within the fork receiving location 992 from the rear face 993 of a pallet 990.

Alternatively, as will also be explained, in some embodiments, the operator may position the at least one lifting fork 190 within a fork receiving location 992 of a pallet 990 to a degree that results in the tip 193 of that lifting fork 190 being positioned flush with the rear face 993 of the pallet (e.g., with the tip 193 in the vertical plane of the rear face 993), or retracted within the fork receiving location 992 from rear face 993 by a relatively small distance as a “cushion” distance between the tip and the rear face 993. Again, such a cushion distance may be 1 to 2 inches (or 5 to 10 centimeters) in length.

In other embodiments, as an alternative to use of the distance sensor 479 to set the zero point distance, the processor component 550 may also operate at least one fork length detector 478 to detect the horizontal length of the support surface 195 of the horizontal portion 192 of at least one lifting fork 190 mounted to the lifting crossbars 181. Again, this may entail directly scanning the support surface 195 to measure its length, or may entail retrieving an indication of its length from a scanned indicia or a received wireless signal. The processor component 550 may then store an indication of that horizontal length as the zero point data 530. In so doing in embodiments in which the settings data 535 includes an indication of an amount of cushion distance (again, 1 to 2 inches, or 5 to 10 centimeters) to be automatically taken into account, the processor component 550 may automatically add the indicated amount of cushion distance to the measured horizontal length before storing an indication of the horizontal length as the zero point data 530.

In executing the calculation component 545, the processor component 550 may retrieve and employ the indication of the zero point distance stored in the zero point data 530 in recurringly calculating a distance to visually indicate on the display 680. More specifically, the processor component 550 may recurringly subtract the zero point distance from the whatever distance is currently detected by the distance sensor 479 (and which has been accepted as the current distance based on such criterion as described earlier). The processor component 550 may then operate the display 680 to visually present the distance that results from the most recent performance of that recurring subtraction. The processor component 550 may present that resulting distance on the display 680 with an indication of whether the resulting distance relative to the zero point distance is a distance to another point that is further away from or closer to the lifting vehicle 100 than the location associated with the zero point distance.

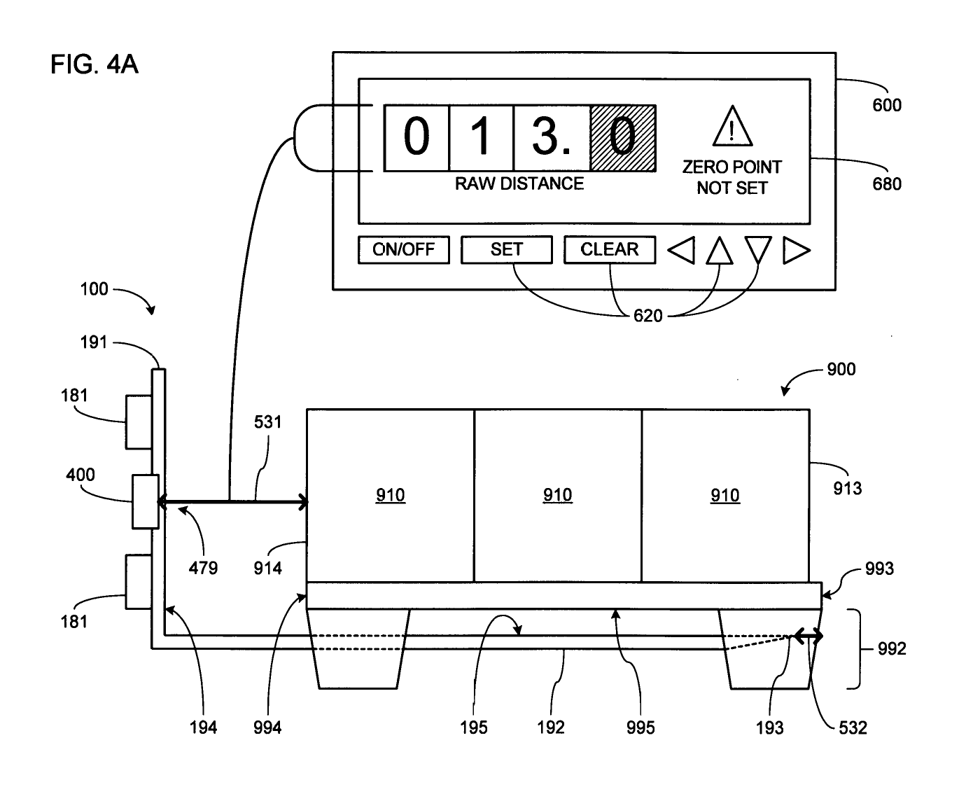

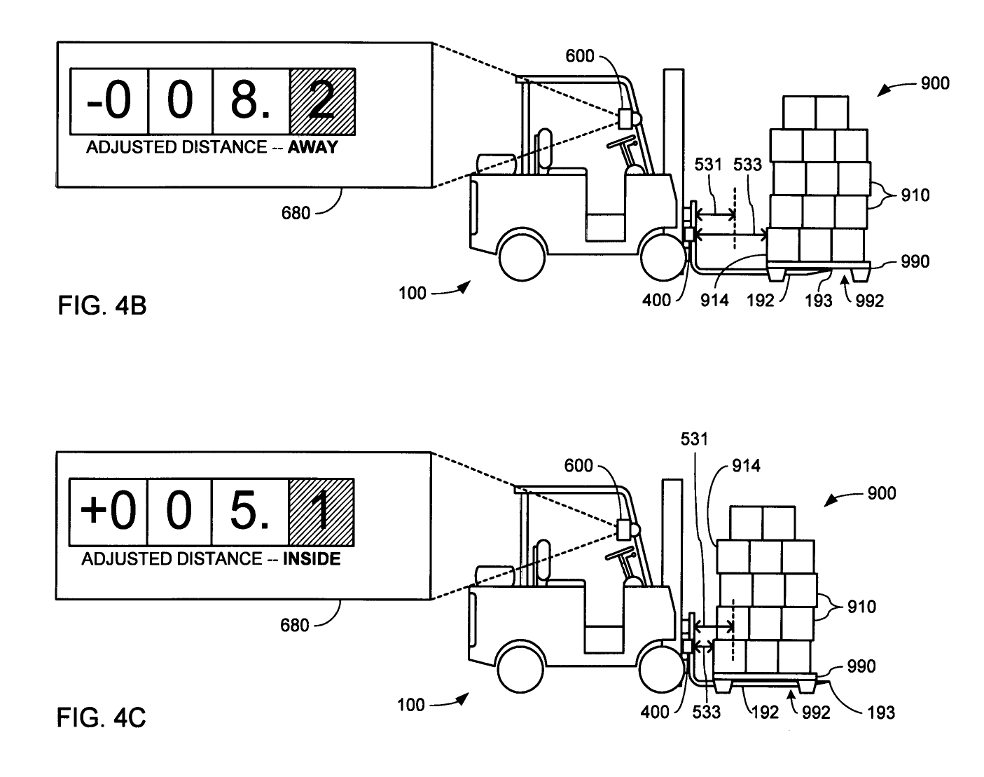

FIGS. 4A through 4C, taken together, depict various aspects of an example of use of an embodiment of the lifting fork positioning system 500 to improve the lifting and moving of palletized loads. Starting with FIG. 4A, elevational views are provided of example preparations of an embodiment of the lifting fork positioning system 500 for use, including an elevational view of the console device 600 from the perspective of an operator of the lifting vehicle 100. As will be explained in more detail, these example preparations may be appropriate for situations in which all of the palletized loads 900 expected to be lifted and/or moved by the lifting vehicle 100 have substantially the same horizontal dimensions.

As depicted, the sensor device 400 is mounted at a location relative to the lifting crossbars 181 of the lifting vehicle 100 in a manner that positions the distance sensor 479 either at or relatively close to the same forward-rearward distance from the body of the lifting vehicle 100 as the vertical surface 194 of the vertical portion 192 of at least one lifting fork 190 mounted on the lifting crossbars 181. Where there is more than one of the lifting forks 190 mounted on the lifting crossbars 181 such that there is more than one vertical surface 194, such multiple vertical surfaces 194 may define a common vertical plane that extends side-to-side and includes each of those vertical surfaces 194. In some embodiments, the sensor device 400 may be mounted to position the distance sensor 479 within or just slightly behind such a plane (i.e., towards the body of the lifting vehicle 100), and not in front of such a plane, to avoid a situation in which the sensor device 400 may be physically damaged if the front face 994 of a pallet 990 and/or the front face 914 of one or more items 910 of a palletized load 900 should become positioned close enough to the body of the lifting vehicle 100 to make contact with one or more of the vertical surfaces 194. In some of such embodiments, the distance sensor 479 may be positioned less than an inch (2.5 centimeters) behind such a plane (i.e., less than an inch in the forward-rearward direction closer to the body of the lifting vehicle 100).

Continuing with FIG. 4A, regardless of the exact forward-rearward positioning of the distance sensor 479 relative to the one or more vertical surfaces 194, and as previously discussed and as depicted more clearly in FIGS. 2B and 2C, the sensor device 400 may be positioned to cause the distance sensor 479 to be oriented forwardly relative to the body of the lifting vehicle 100 to measure distances to objects that are positioned forwardly (in front of) the lifting vehicle 100. More precisely, the distance sensor 479 may be positioned in a forwardly facing orientation that parallels the direction in which the horizontal portion 192 of each lifting fork 190 mounted on the lifting crossbars 181 extends. In this way, the distances detected by the distance sensor 479 are distances from the distance sensor 479 and to objects forwardly further away than the distance sensor 479 from the body of the lifting vehicle 100.

With the distance sensor 479 positioned as just described, the distance sensor 479 may emit sound (e.g., ultrasound) and/or light (e.g., laser light and/or a projected pattern of light) in the forwardly facing direction in which the distance sensor 479 is oriented to attempt to measure a distance to an object currently in front of the lifting vehicle 100. Such an object may be the depicted example of a palletized load 900 positioned within range of the distance sensor 479 such that the distance sensor 479 is able to measure a distance from the distance sensor 479 to a front face 914 of at least one item 910 of the palletized load 900, and/or to a front face 994 of the pallet 990 of the palletized load 900. More precisely, and as depicted, the one or more lifting forks 190 may be positioned relative to the pallet 990 of the palletized load 900 such that the one or more lifting forks 190 may extend into corresponding fork receiving locations 992 of the pallet 990. As a result, the front faces 914 and/or 994 may come to be positioned relatively close to the vertical surface 194 of the vertical portion 191 of each of the one or more lifting forks 190, as well as having come to be positioned relatively close to the distance sensor 479 of the sensor device 400. Also a result, the sound and/or light emissions of the distance sensor 479 may encounter the front face 914 and/or the front face 994, and may be reflected back to the distance sensor 479, thereby enabling the distance sensor 479 to employ any of a variety of types of analysis appropriate to the technology of the distance sensor 479 to detect the current distance between the distance sensor 479 and the front face 914 and/or the front face 994.

As also depicted, the current distance detected by the distance sensor 479 may be visually presented on the display 680. As has been described, the processor component 550 may, in executing the control routine 540 (e.g., the measurement component 547), be caused to recurringly operate the distance sensor 479 to recurringly detect the current distance to an object at a location in front of the lifting vehicle 100 (more precisely, in the path of the sound and/or light emitted by the distance sensor 479). As has also been described, the processor component 550 may, in executing the control routine 540 (e.g., the UI component 548), recurringly visually present an indication of that recurringly measured current distance on the display 680. As depicted, the current distance may be visually presented in numerical form as a quantity of a selected unit of measure (e.g., inches, feet, meters, centimeters, etc.). However, other embodiments are possible in which the visual presentation of the current distance entails visually presenting graphical representations of objects in addition to or in lieu of a numerical form of visual presentation, such as a depiction of relative positions of at least a portion of a lifting fork and at least a portion of a palletized load. Such depictions may be somewhat simplified (e.g., cartoon-like) representations of such objects, and not images of actual ones of such objects.

Continuing with FIG. 4A, in some embodiments, the processor component 550 may also be caused to operate the display 680 to visually present one or more indications of the current status of the lifting fork positioning system 500, including whether or not a zero point distance has been set. By way of example, and as depicted, the numerical presentation of the current distance on the display 680 may be accompanied by text and/or a graphical element indicating that no zero point distance has been set (e.g., the depicted exclamation point within a triangle accompanied by such text). By way of another example, and as also depicted, the numerical visual presentation of the current distance may be accompanied by text indicating that the current distance, as displayed, is not adjusted in any way based on zero point distance.

In some embodiments, the presentation of one or more of such visual indicators that no zero point distance has been set may serve as a prompt to an operator of the lifting vehicle 100 to do so. After causing one or more of such visual indicators to be visually presented on the display 680, the processor component 550 may be caused to recurringly monitor the one or more manually operable controls 620 of the console device 600 for an indication of manual operation thereof to input a command to set the zero point distance (e.g., manual operation of the depicted button labeled “SET” among the controls 620). Alternatively, in embodiments in which the display 680 is touch-sensitive, the processor component 550 may monitor touch-sensitive components of the display 680 for an indication of a region of the displayable area of the display 680 having been touched in a manner that is an input of such a command. In response to such a command being received as an input (through one of the controls 620 and/or through touch-sensitive components of the display 680), the processor component 550 may store an indication of the current distance detected by the distance sensor 479 in the zero point data 530 as the zero point distance 531. The processor component 550 may also respond by removing indication(s) visually presented on the display 680 to the effect that no zero point distance has been set, and/or may cause the visual presentation of one or more indications that the zero point distance 531 has been set.

It should be noted that, in some embodiments in which the sensor device 400 may be positioned more rearwardly or forwardly relative to the body of the lifting vehicle 100 than the vertical surface 194 of each of one or more lifting forks 190, the processor component 550 may be caused by its execution of the control routine 540 (e.g., the measurement component 547) to compensate for such positioning in the measuring of distances performed using the distance sensor 479. More specifically, the processor component 550 may visually present an option in a menu for an operator of the lifting vehicle 100 (or other personnel installing or maintaining the lifting fork positioning system 500) to provide an indication of the distance by which the distance sensor 479 may be positioned either less forwardly (toward the body of the lifting vehicle 100) or more forwardly than the vertical surface(s) 194 of the one or more lifting forks 190 mounted on the lifting crossbars 181. As part of presenting such an option to provide such input, the processor component 550 may be caused to monitor one or more of the manually operable controls 620 (e.g., the depicted arrow-shaped buttons among the controls 620 for navigating a menu) and/or to monitor touch-sensitive components of the display 680 (in embodiments in which the display 680 is touch-sensitive) for indications of such a distance having been input. Upon receiving such input, the processor component 550 may be caused to store an indication of such a distance as a measurement adjustment distance in the settings data 535 along with indications of other parameters.

With the indication of such a measurement adjustment distance so stored, the processor component 550 may employ the measurement adjustment distance in adjusting each measurement of a distance provided by the distance sensor 479 to compensate for such a difference in forward-rearward positioning of the distance sensor 479 relative to the one or more vertical surfaces 194. Alternatively, in other embodiments, it may be that the distance sensor 479 is itself capable of making such adjustments in the measurements of distance that it provides to the processor component 550. In such other embodiments, the processor component 550 may provide an indication of the measurement adjustment distance to the distance sensor 479 for it to use in effecting such adjustments to the distances that it detects.

Continuing with FIG. 4A, it should be understood that, as depicted, the zero point distance 531 is the distance to the front faces 914 and/or 994 of the depicted palletized load 900 with the front faces 914 and/or 994 being closer to the distance sensor 479 in the forward-rearwardly direction than the tip 193 of each of the one or more lifting forks 190 installed on the lifting crossbars 181. With the front faces 914 and/or 994 at such a close distance to the distance sensor 479, the horizontal portion 192 of each of the one or more lifting forks 190 extend into corresponding fork receiving locations 992 of the depicted pallet 990.

The setting of the zero point distance 531 with the front faces 914 and/or 994 at such a closer distance to the distance sensor 479 may be deemed desirable where all of the palletized loads 900 to be lifted and/or moved have at least one horizontal dimension in common such that the distance from the front faces 914 and/or 994, and to the rear faces 913 and/or 993 is expected to be similar for all of those palletized loads 900. As will shortly be explained, an operator of the lifting vehicle 100 may then guide their operation of the lifting vehicle 100 in positioning the horizontal portion 192 of the one or more lifting forks 190 relative to the pallet 990 of each of those palletized loads 990 by seeking to achieve an indication on the display 680 of having reached a distance to the front faces 914 and/or 994 thereof that matches the zero point distance 531 as closely as possible. In essence, by setting the zero point distance 531 with the front faces 914 and/or 994 of the depicted palletized load at the depicted distance from the distance sensor 479 (i.e., a distance closer thereto than the tip 193 of the depicted lifting fork 190), the depicted relative positioning of the depicted lifting fork 190 and the depicted palletized load 900 is used as a type of “template” for such relative positioning for each subsequently lifted and/or moved palletized load 900.

It should also be understood that in creating such a “template” for such relative positioning, the operator of the lifting vehicle may choose to position the horizontal portion 192 of the depicted lifting fork 190 relative to the pallet 990 of the depicted palletized load 900 such that the horizontal portion 192 of the depicted lifting fork 190 does not extend fully all the way through the fork receiving location 992 and the tip 193 thereof does not extend as far forward from the body of the lifting vehicle 100 as the rear faces 913 and/or 993 of the depicted palletized load 900. As previously explained, this may be done in compliance with a policy in favor of ensuring that no tip 193 of any lifting fork 190 ever extends beyond (i.e., further forward relative to the body of the lifting vehicle 100 than) the rear faces 913 and/or 993 of a palletized load 900 by always intentionally leaving a cushion distance 532 between the tip 193 and the rear faces 913 and/or 993.

Each of FIGS. 4B and 4C provides elevational views of an example use of the embodiment of the lifting fork positioning system 500 of FIG. 4A, including an elevational view of the console device 600 from the perspective of an operator of the lifting vehicle 100. The example use depicted in each of FIGS. 4B and 4C is in positioning the horizontal portion 192 of at least one lifting fork 190 relative to a pallet 990 of another palletized load 900 at a time after use of the palletized load 900 depicted in FIG. 4A to set the zero point distance 531.

Turning to FIG. 4B, in positioning the horizontal portion 192 of at least one lifting fork 190 relative to the pallet 990 of another palletized load 900, the front faces 914 and/or 994 of the other palletized load 900 are at a current distance 533 from the distance sensor 479 of the sensor device 400 that is greater than the zero point distance 531 set in FIG. 4A. As the effort at positioning at least the depicted horizontal portion 192 relative to the depicted pallet 990 occurs, the processor component may be caused to continue to recurringly operate the distance sensor 479 to recurringly detect the current distance 533 from the distance sensor 479 to the front faces 914 and/or 994 of the other palletized load 900. The processor component 550 may also be caused by continued execution of the control routine 540 (e.g., the calculation component 545) to recurringly subtract the zero point distance 531 from the current distance 533 to recurringly derive a distance value that indicates the magnitude of the difference between the distances 531 and 533. The processor component 550 may then visually present the recurringly derived value of that magnitude of difference in distances on the display 680.

In various embodiments, the processor component 550 may visually present the recurringly derived value of magnitude of difference along with a visual indication of whether that value corresponds to a current distance 533 that extends further forward and away from the body of the lifting vehicle 100 than the zero point distance 531, or corresponds to a current distance 533 that extends less forward than the zero point distance 531, based on a comparison by the processor component 550 of the lengths of these two distances. In some embodiments, such a visual indication may include the use of alphanumeric characters such as a plus sign character (i.e., “+”) and/or a minus sign character (i.e., “−”).

By way of example, and as depicted in FIG. 4B, the visual presentation of a minus sign character beside a visual presentation of the recurringly derived value of magnitude of difference in distances may signify that the current distance 533 of the front faces 914 and/or 994 of the other palletized load 900 is further away (i.e., further forward from the body of the lifting vehicle 100) than the zero point distance 531. Alternatively or additionally, and as also depicted, a textual indication may be visually presented that indicates that the visually presented distance value is the magnitude of difference between the current distance 533 and the zero point distance 513, and that the visually presented distance value is of how much further forward (i.e., further “AWAY”) the faces 914 and/or 994 of the other palletized load 900 are from forward portions of the lifting vehicle 100 than the zero point distance 531.

Turning to FIG. 4C, a situation somewhat opposite to that of FIG. 4B is depicted. As in FIG. 4B, a positioning of the horizontal portion 192 of at least one lifting fork 190 relative to the pallet 990 of another palletized load 900 is underway in FIG. 4C. However, unlike what is depicted in FIG. 4B, the front faces 914 and/or 994 of the other palletized load 900 are at a current distance 533 from the distance sensor 479 of the sensor device 400 that is less than the zero point distance 531 set in FIG. 4A.

As in the situation depicted in FIG. 4B, during the effort to position at least the depicted horizontal portion 192 relative to the depicted pallet 990, the processor component may be caused to continue to recurringly operate the distance sensor 479 to recurringly detect the current distance 533 from the distance sensor 479 to the front faces 914 and/or 994 of the other palletized load 900. Again, in so doing, the processor component 550 may also be caused to recurringly subtract the zero point distance 531 from the current distance 533 to recurringly derive a distance value that indicates the magnitude of the difference between the distances 531 and 533. The processor component 550 may then visually present the recurringly derived value of that magnitude of difference in distances on the display 680.

As discussed in reference to FIG. 4B, the processor component 550 may visually present the recurringly derived value of magnitude of difference along with a visual indication of whether that value corresponds to a current distance 533 that is further forward and away from the body of the lifting vehicle 100 than the zero point distance 531, or corresponds to a current distance 533 that is less forward and closer to the body of the lifting vehicle 100 than the zero point distance 531. By way of example, and as depicted in FIG. 4C, the visual presentation of a plus sign character beside a visual presentation of the recurringly derived value of magnitude of difference in distances may signify that the current distance 533 of the front faces 914 and/or 994 of the other palletized load 900 is closer (i.e., not as far forward from the body of the lifting vehicle 100) than the zero point distance 531. Alternatively or additionally, and as also depicted, a textual indication may be visually presented that indicates that the visually presented distance value is the magnitude of difference between the current distance 533 and the zero point distance 513, and that the visually presented distance value is of how much closer the faces 914 and/or 994 of the other palletized load 900 are to forward portions of the lifting vehicle 100 than the zero point distance 531 (i.e., how much further “INSIDE”).

Referring to both FIGS. 4B and 4C, and as previously discussed in reference to FIG. 4A, the manner in which an operator of the lifting vehicle 100 may employ the information visually presented on the display 680 of the console device 600 is to seek to achieve, as close as possible, a visually presented zero value as an indication of magnitude of difference between a current distance 533 and the zero point distance 531. Stated differently, with the zero point distance 531 having been set in FIG. 4A based on a desired positioning of the one or more lifting forks 190 of the lifting vehicle 100 relative to a palletized load 900, the goal for subsequent positioning of the one or more lifting forks 190 relative to other palletized loads 900 is to achieve as small a difference between the zero point distance 531 and the current distance 533 to the front faces 914 and/or 994 of each such palletized load 900 as possible.

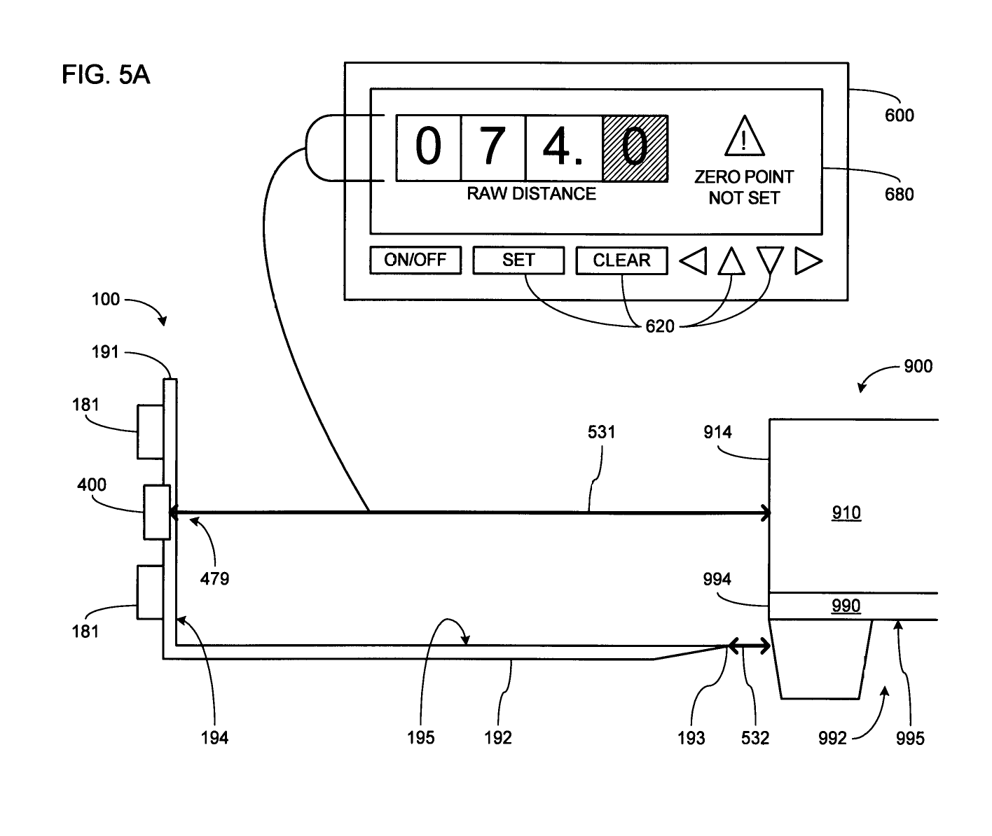

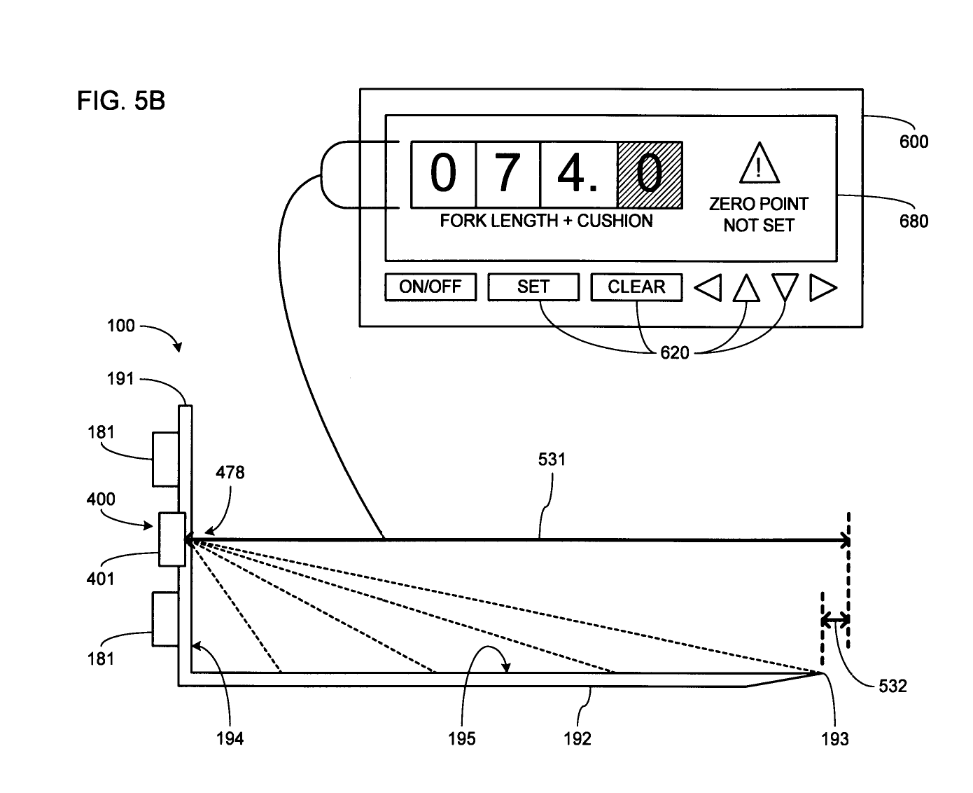

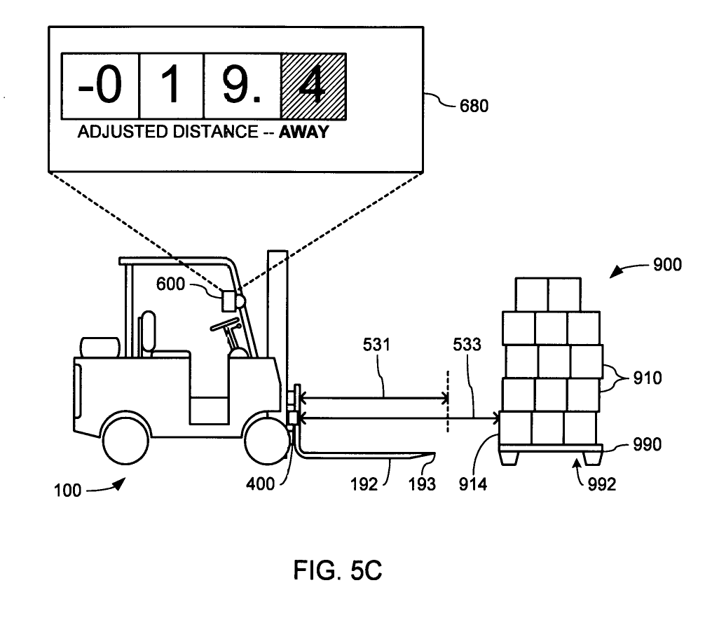

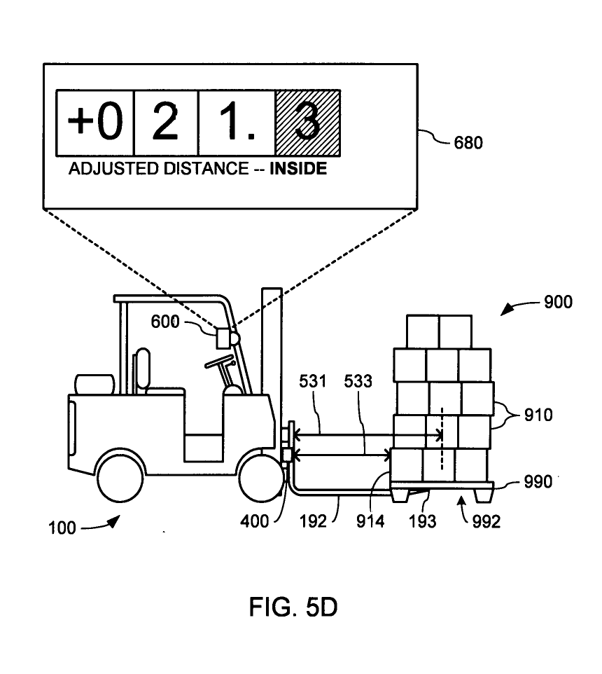

FIGS. 5A through 5D, taken together, depict various aspects of another example of use of an embodiment of the lifting fork positioning system 500 to improve the lifting and moving of palletized loads. Starting with FIG. 5A, elevational views are provided of example preparations of an embodiment of the lifting fork positioning system 500 for use, including an elevational view of the console device 600 from the perspective of an operator of the lifting vehicle 100. Unlike the earlier example of FIG. 4A, these example preparations of FIG. 5A may be more appropriate for situations variations are expected in the horizontal dimensions of the palletized loads 900 to be lifted and/or moved by the lifting vehicle 100.

Similar to what was depicted and discussed in reference to FIG. 4A, in FIG. 5A, the sensor device 400 may be mounted at a location relative to the lifting crossbars 181 of the lifting vehicle 100 in a manner that positions the distance sensor 479 either at or relatively close to the same forward-rearward distance from the body of the lifting vehicle 100 as the vertical surface 194 of the vertical portion 192 of at least one lifting fork 190 mounted on the lifting crossbars 181. Again, the distance sensor 479 may be positioned in a forwardly facing orientation that parallels the direction in which the horizontal portion 192 of each lifting fork 190 mounted on the lifting crossbars 181 extends.

Continuing with FIG. 5A, with the distance sensor 479 positioned as just described, the distance sensor 479 may emit sound and/or light in the forwardly facing direction in which the distance sensor 479 is oriented to attempt to measure a distance to an object currently in front of the lifting vehicle 100. Again, such an object may be the depicted example of a palletized load 900 positioned within range of the distance sensor 479 such that the distance sensor 479 is able to measure a distance from the distance sensor 479 to a front face 914 of at least one item 910 of the palletized load 900 and/or to a front face 994 of the pallet 990 of the palletized load 900. More precisely, and as depicted, the one or more lifting forks 190 may be positioned relatively close to the front faces 914 and/or 994 of the depicted palletized load 900 without the tip 193 of any of the one or more lifting forks 190 entering into any of the fork receiving locations 992 of the pallet 990. This may also place the front faces 914 and/or 994 well within range of being detected by the distance sensor 479.

Similar to what was depicted and discussed in reference to FIG. 4A, in FIG. 5A, the current distance detected by the distance sensor 479 may be visually presented on the display 680. Again, as has been described, the processor component 550 may be caused to recurringly operate the distance sensor 479 to recurringly detect the current distance to an object at a location in front of the lifting vehicle 100, and may recurringly visually present an indication of that recurringly measured current distance on the display 680. Again, the current distance may be visually presented in numerical form as a quantity of a selected unit of measure (e.g., inches, feet, meters, centimeters, etc.). However, other embodiments are possible in which the visual presentation of the current distance entails visually presenting graphical representations of objects in addition to or in lieu of a numerical form of visual presentation, such as a depiction of relative positions of at least a portion of a lifting fork and at least a portion of a palletized load.

Continuing with FIG. 5A, in some embodiments, the processor component 550 may also be caused to operate the display 680 to visually present one or more indications of the current status of the lifting fork positioning system 500, including whether or not a zero point distance has been set. Again, in response to a command to set the zero point distance having been received, the processor component 550 may store an indication of the current distance detected by the distance sensor 479 in the zero point data 530 as the zero point distance 531. The processor component 550 may also respond by removing indication(s) visually presented on the display 680 that no zero point distance has been set, and/or may visually present one or more indications that the zero point distance 531 has been set on the display 680.

Again, it should be noted that the processor component 550 may additionally operate the display 680 and/or 620 to enable entry of a measurement adjustment distance, and may store an indication of that adjustment distance as part of the settings data 535. With the indication of such a measurement adjustment distance so stored, the processor component 550 may employ the measurement adjustment distance in adjusting each measurement of a distance provided by the distance sensor 479 to compensate for such a difference in forward-rearward positioning of the distance sensor 479 relative to the one or more vertical surfaces 194. Alternatively, in other embodiments where the distance sensor 479 is itself capable of making such adjustments in the measurements of distance that it provides to the processor component 550, the processor component 550 may provide an indication of the measurement adjustment distance to the distance sensor 479 for it to use in effecting such adjustments to the distances that it detects.

It should be understood that, as depicted, the zero point distance 531 is the distance to the front faces 914 and/or 994 of the depicted palletized load 900 with the front faces 914 and/or 994 being at a distance just beyond the tip 193 of each of the one or more lifting forks 190 installed on the lifting crossbars 181. The setting of the zero point distance 531 with the front faces 914 and/or 994 at such a distance beyond the tip 193 of each of the one or more lifting forks 190 may be deemed desirable where the palletized loads 900 to be lifted and/or moved may have various different horizontal dimensions among them such that the horizontal portion 192 of each of the one or more lifting forks 190 may need to be inserted into the pallets 990 of different ones of those palletized loads 900 to differing degrees to provide appropriate physical support during lifting to each, while avoiding having the tip 193 of each of the one or more lifting forks 190 extending beyond the rear faces 913 and/or 993 thereof.

Continuing with FIG. 5A, as will shortly be explained, the ability of an operator of the lifting vehicle 100 to discern the horizontal dimensions of each of those palletized loads 900 may be relied upon as part of employing the lifting fork positioning system 500. In essence, by setting the zero point distance 531 with the front faces 914 and/or 994 of the depicted palletized load at the depicted distance from the distance sensor 479 (i.e., a distance that extends just beyond the distance to the tip 193 of the depicted lifting fork 190), the zero point distance 531 is made relatively similar to the length of the support surface 195 of the horizontal portion 192 of the depicted lifting fork 190.

It should also be understood that the operator of the lifting vehicle may choose to position the horizontal portion 192 of the depicted lifting fork 190 relative to the pallet 990 of the depicted palletized load 900 such that the tip 193 is separated from the front face 994 of the depicted pallet 990 by a distance chosen by the operator to become the cushion distance 532. As will be explained, reliance on the ability of the operator to discern the horizontal dimensions of palletized loads 900 may be relied upon, in combination with use of the lifting fork positioning system 500 to cause the horizontal portion 192 of each of the one or more forks mounted on the lifting crossbars 181 to extend into corresponding fork receiving locations 992 far enough to provide appropriate physical support during lifting, while also causing the tip 193 of each of those one or more lifting forks 190 to be positioned so as to be separated from the rear faces 913 and/or 993 by the cushion distance 532.

FIG. 5B provides elevational views, similar to those of FIG. 5A, of a more automated embodiment of the preparations depicted and discussed in reference to FIG. 5A. In a manner similar to what is depicted and discussed in FIG. 5A, a visual prompt to set the zero point distance 531 may be presented on the display 680, and the processor component 550 may be caused to await an indication of operation of a control 620 and/or a touch-sensitive component of the display 680 to input a command to do so.

However, unlike what was depicted and discussed in reference to FIG. 5A, in response to the receipt of such a command as input, the processor component 550 may operate one or more fork length detectors 478 to determine the horizontal length of the support surface 195 provided by the horizontal portion 192 of at least one of the one or more lifting forks 190 mounted on the lifting crossbars 181. As previously discussed, various technologies may be employed by various possible implementations of one or more fork length detectors 478 in determining such horizontal lengths. Again, a fork length detector 478 may receive RF communications indicating such a horizontal length for at least one support surface 195 from a RFID tag affixed or otherwise carried by at least one of the one or more lifting forks 190. Alternatively, a fork length detector 478 may optically scan indicia (e.g., a barcode, symbol, alphanumeric character, color code, etc.) affixed to or otherwise carried by at least one of the one or more lifting forks 190, and where the indicia provides an indication of the horizontal length.

As still another alternative, and as depicted in FIG. 5B, a fork length detector 478 may employ any of a variety of optical scanning techniques to scan the support surface 195 of at least one of the one or more lifting forks 190 mounted on the lifting crossbars 181 of the lifting vehicle 100 to determine the horizontal length thereof. An advantage that each of these approaches to determining the horizontal length of the support surface 195 of each of the one or more lifting forks 190 is the lack of need for the operator of the lifting device 100 to rely upon the positioning of the one or more lifting forks 190 in any particular configuration relative to a palletized load 900.

In some embodiments, the determined horizontal length of the support surface 195 of at least one of the one or more lifting forks 190 may be stored by the processor component 550 as the zero point distance 531 in the zero point data 530. However, as has been discussed, it may be deemed desirable to employ a cushion distance 532 by which the tip 193 of the horizontal portion 192 of each of the one or more lifting forks 190 may remain recessed within corresponding ones of the fork receiving locations 992 of a pallet relative to the rear face 993 thereof. Thus, in some embodiments, the processor component 550 may automatically add the length of the cushion distance 532 to the horizontal length of the support surface 195 of at least one of the one or more lifting forks 190 to derive the zero point distance 531 that the processor component 550 then stores as the zero point data 530.

In some of such embodiments, the processor component 550 may operate the display 680 and/or the controls 620 to provide a menu option that allows an operator of the lifting vehicle 100 to input a desired cushion distance 532 for the processor component 550 to automatically add to the horizontal distance of the support surface 195 of at least one of the one or more lifting forks 190.

Each of FIGS. 5C and 5D provides elevational views of an example use of the embodiment of the lifting fork positioning system 500 of either FIG. 5A or 5B, including an elevational view of the console device 600 from the perspective of an operator of the lifting vehicle 100. The example use depicted in each of FIGS. 5C and 5D is in positioning the horizontal portion 192 of at least one lifting fork 190 relative to a pallet 990 of another palletized load 900 at a time after use of the palletized load 900 depicted in FIG. 5A to set the zero point distance 531, or after the use of no palletized load 900 at all in FIG. 5B to set the zero point distance 531.

Turning to FIG. 5C, in positioning the horizontal portion 192 of at least one lifting fork 190 relative to the pallet 990 of another palletized load 900, the front faces 914 and/or 994 of the other palletized load 900 are at a current distance 533 from the distance sensor 479 of the sensor device 400 that is greater than the zero point distance 531 set in either FIG. 5A or 5B. As the effort at positioning at least the depicted horizontal portion 192 relative to the depicted pallet 990 occurs, the processor component may be caused to continue to recurringly operate the distance sensor 479 to recurringly detect the current distance 533 to the front faces 914 and/or 994 of the other palletized load 900. The processor component 550 may also be caused to recurringly subtract the zero point distance 531 from the current distance 533 to recurringly derive a distance value that indicates the magnitude of the difference between the distances 531 and 533. The processor component 550 may then visually present the recurringly derived value of that magnitude of difference in distances on the display 680.

In a manner similar to what was earlier discussed in reference to FIGS. 4B and 4C, the processor component 550 may visually present the recurringly derived value of magnitude of difference along with a visual indication of whether that value corresponds to a current distance 533 that extends further forward and away from the body of the lifting vehicle 100 than the zero point distance 531, or corresponds to a current distance 533 that extends less forward from the body of the lifting vehicle 100 than the zero point distance 531, based on a comparison of lengths of the current distance 533 and the zero point distance 531 by the processor component 550. Again, in some embodiments, such a visual indication may include the use of alphanumeric characters such as a plus sign character (i.e., “+”) and/or a minus sign character (i.e., “−”).

By way of example, and as depicted in FIG. 5C, the visual presentation of a minus sign character beside a visual presentation of the recurringly derived value of magnitude of difference in distances may signify that the current distance 533 of the front faces 914 and/or 994 of the other palletized load 900 is further away (i.e., further forward from the body of the lifting vehicle 100) than the zero point distance 531. Alternatively or additionally, a textual indication may be visually presented that indicates that the visually presented distance value is the magnitude of difference between the current distance 533 and the zero point distance 513, and that the visually presented distance value is of how much further forward (i.e., further “AWAY”) the faces 914 and/or 994 of the other palletized load 900 are from forward portions of the lifting vehicle 100 than the zero point distance 531.

Turning to FIG. 5D, a situation somewhat opposite to that of FIG. 5C is depicted. As in FIG. 5C, a positioning of the horizontal portion 192 of at least one lifting fork 190 relative to the pallet 990 of another palletized load 900 is underway in FIG. 5D. However, unlike what is depicted in FIG. 5C, the front faces 914 and/or 994 of the other palletized load 900 are at a current distance 533 from the distance sensor 479 of the sensor device 400 that is less than the zero point distance 531 set in either FIG. 5A or 5B.

As in the situation depicted in FIG. 5C, during the effort to position at least the depicted horizontal portion 192 relative to the depicted pallet 990, the processor component may be caused to continue to recurringly operate the distance sensor 479 to recurringly detect the current distance 533 from the distance sensor 479 to the front faces 914 and/or 994 of the other palletized load 900. Again, in so doing, the processor component 550 may also be caused to recurringly subtract the zero point distance 531 from the current distance 533 to recurringly derive a distance value that indicates the magnitude of the difference between the distances 531 and 533. The processor component 550 may then visually present the recurringly derived value of that magnitude of difference in distances on the display 680.

As discussed in reference to FIG. 5C, the processor component 550 may visually present the recurringly derived value indicating the magnitude of the difference between the distances 531 and 533 on the display 680. Along with that value, the processor component may also visually present a visual indication of whether that value corresponds to a current distance 533 that is further forward and away from the body of the lifting vehicle 100 than the zero point distance 531, or corresponds to a current distance 533 that is less forward and closer to the body of the lifting vehicle 100 than the zero point distance 531. By way of example, and as depicted in FIG. 5D, the visual presentation of a plus sign character beside a visual presentation of the recurringly derived value of magnitude of difference in distances may signify that the current distance 533 of the front faces 914 and/or 994 of the other palletized load 900 is closer (i.e., not as far forward from the body of the lifting vehicle 100) than the zero point distance 531. Alternatively or additionally, and as also depicted, a textual indication may be visually presented that indicates that the visually presented distance value is the magnitude of difference between the current distance 533 and the zero point distance 513, and that the visually presented distance value is of how much closer the faces 914 and/or 994 of the other palletized load 900 are to forward portions of the lifting vehicle 100 than the zero point distance 531 (i.e., how much further “INSIDE”).

Referring to both FIGS. 5C and 5D, and as previously discussed in reference to FIG. 5A, the manner in which an operator of the lifting vehicle 100 may employ the information visually presented on the display 680 of the console device 600 entails relying on the operator to be able to discern, for each palletized load 900, the distance from the front faces 914 and/or 994, and to the rear faces 913 and/or 993. Using that distance discerned for each palletized load 900, the operator then seek to achieve, as close as possible, a visually presented value of the magnitude of difference between a current distance 533 and the zero point distance 531 that is equal to that distance from the front faces 914 and/or 994, and to the rear faces 913 and/or 993. Stated differently, with the zero point distance 531 having been set in FIG. 5A or 5B based on the horizontal length of the support surface 195 of at least one lifting fork 190 (e.g., either equal to that horizontal distance, or equal to that horizontal distance plus the cushion distance 532), the goal for subsequent positioning of the one or more lifting forks 190 relative to other palletized loads 900 is to match achieve a difference between the zero point distance 531 and the current distance 533 to the front faces 914 and/or 994 of each palletized load 900 that is equal to the distance between the front faces 914 and/or 994 and the rear faces 913 and/or 993 of that palletized load 900. By doing so, the tip 193 of each of the one or more lifting forks 190 may be located within corresponding fork receiving locations 992 at a distance recessed from the rear faces 913 and/or 993 equal to the cushion length 532.

Still further, in some embodiments where the zero point distance 531 is based on the horizontal length of the support surface 195 of at least one lifting fork 190, the processor component 550 may be caused to visually present warnings of the possibility of an unsafe condition being created based on comparisons of the zero point distance 531 to other distance values. By way of example, the processor component may operate the display 680 and/or the controls 620 to provide a menu option to input one or both of a minimum horizontal dimension and a maximum horizontal dimension for all palletized items expected to be lifted and/or moved by the lifting vehicle 100. In other words, the opportunity may be provided to the operator to input minimum and maximum distances from the front faces 914 and/or 994 to the rear faces 913 and/or 993 that are expected to be encountered with any palletized load 900.

With such values thusly provided, along with the zero distance length 531, the processor component 550 may recurringly analyze indications of the current distance 533 from the distance sensor 479 in view of such values to identify situations where it may be that the conditions for an accident have been and/or are being created. By way of example, if 1) the minimum horizontal dimension for a palletized load 900 has been indicated to be 24 inches (i.e., the minimum distance between the front faces 914 and/or 994 and the rear faces 913 and/or 993 is indicated to be 24 inches), 2) the one or more lifting forks 190 have been inserted into corresponding fork receiving locations 992 to a degree that is not sufficient to properly support even a palletized load with a horizontal dimension of 24 inches, and 3) there is no further movement of the one or more lifting forks 190 deeper into the corresponding fork receiving locations 992 for at least a predetermined period of time, then the processor component 550 may operate the display 680 to visually present a warning of such improper positioning of the one or more lifting forks 190. Also by way of example, if 1) the maximum horizontal dimension for a palletized load 900 has been indicated to be 48 inches (i.e., the maximum distance between the front faces 914 and/or 994 and the rear faces 913 and/or 993 is indicated to be 48 inches), 2) the one or more lifting forks 190 have been inserted into corresponding fork receiving locations 992 to a degree that is sufficient to cause the tip 193 of each of the one or more forks to extend beyond the rear faces 913 and/or 993 of even a palletized load with a horizontal dimension of 48 inches, and 3) there is no further movement of the one or more lifting forks 190 rearwardly back out of the corresponding fork receiving locations 992 for at least a predetermined period of time, then the processor component 550 may operate the display 680 to visually present a warning of such improper positioning of the one or more lifting forks 190.

Although the invention has been described in a preferred form with a certain degree of particularity, it is understood that the present disclosure of the preferred form has been made only by way of example, and that numerous changes in the details of construction and the manner of manufacture may be resorted to without departing from the spirit and scope of the invention. It is intended to protect whatever features of patentable novelty exist in the invention disclosed.

1. A lifting fork positioning system comprising:
a sensor device comprising a distance sensor to recurringly detect a current distance extending forwardly from a forward portion of a lifting vehicle and to a front face of a palletized load that faces the lifting vehicle when the sensor device is carried by the lifting vehicle with the distance sensor oriented to face forwardly from the lifting vehicle, wherein:
the lifting vehicle comprises a lifting mechanism to cooperate with a lifting fork to lift the palletized load when the lifting fork is mounted on the lifting mechanism;
the lifting fork comprises an elongate horizontal portion that extends lengthwise and forwardly of the lifting vehicle toward the palletized load when the lifting fork is mounted on the lifting mechanism;
the horizontal portion of the lifting fork comprises an elongate upwardly-facing support surface;
the palletized load comprises a pallet that defines at least one fork receiving location to receive the elongate horizontal portion; and
the fork receiving location comprises a downwardly-facing support surface to be engaged by the upwardly-facing support surface of the horizontal portion of the lifting fork to enable lifting of the palletized load by the lifting vehicle via the lifting mechanism and the lifting fork;
a console device comprising a display; and
a processor component and a storage incorporated into one of the sensor device and the console device, wherein the storage stores instructions that, when executed by the processor component, cause the processor component to:
recurringly determine whether a zero point distance is currently set, wherein the zero point distance extends forwardly of the lifting vehicle and in parallel with the current distance to the front face of the palletized load; and
in response to the zero point distance being currently set:
recurringly compare lengths of the current distance and the zero point distance;
recurringly subtract the length of the zero point distance from the length of the current distance to recurringly derive a magnitude of difference between the lengths of the current distance and the zero point distance;
visually present the magnitude of the difference on the display;
visually present, on the display, an indication that the front face of the palletized load is closer to the lifting vehicle in response to the length of the current distance being greater than the length of the zero point distance; and
visually present, on the display, an indication that the front face of the palletized load is further away from the lifting vehicle in response to the length of the zero point distance being greater than the length of the current distance.

2. The lifting fork positioning system of claim 1, wherein the distance sensor emits at least one of sound or light toward the front face of the palletized load to be reflected back to the distance sensor, and the distance sensor analyzes the reflected sound or light to detect the current distance.

3. The lifting fork positioning system of claim 1, wherein the indication that the front face of the palletized load is closer to the lifting vehicle and the indication that the front face of the palletized load is further away from the lifting vehicle each comprise one of a minus sign (“−”) and a plus sign (“+”).

4. The lifting fork positioning system of claim 1, wherein the processor component is caused to, in response to the zero point distance not being currently set:
visually present an indication that the zero point distance is not currently set on the display;
visually present the current distance on the display;
await receipt of a command to set the zero point distance; and
in response to receipt of the command to set the zero point distance, store the current distance that is currently detected by the sensor device in the storage as the zero point distance.

5. The lifting fork positioning system of claim 4, wherein the display comprises a touch-sensitive display, and the processor component is caused to monitor a touch-sensitive component of the display for receipt of the command to set the zero point distance.

6. The lifting fork positioning system of claim 1, wherein:
the sensor device comprises a fork length detector to detect a length of the elongate upwardly-facing support surface of the horizontal portion of the lifting fork; and
the processor component is caused to, in response to the zero point distance not being currently set:
visually present an indication that the zero point distance is not currently set on the display;
visually present the current distance on the display;
await receipt of a command to set the zero point distance; and
in response to receipt of the command to set the zero point distance, operate the fork length detector to detect the length of the support surface of the horizontal portion, and store the length of the support surface of the horizontal portion in the storage as the zero point distance.

7. The lifting fork positioning system of claim 6, wherein the fork length detector comprises at least one of:
an optical scanning component to scan the support surface of the horizontal portion of the lifting fork;
an optical scanning component to scan one or more surfaces of the lifting fork for an indicia that indicates the length of the support surface; and
a radio frequency identification (RFID) reader to electromagnetically transmit electric power to energize a RFID tag carried by the lifting fork and to receive a signal from the RFID tag that conveys an indication of the length of the support surface.

8. The lifting fork positioning system of claim 6, wherein the processor component is caused to:
visually present an option for an operator of the lifting vehicle to specify a cushion distance at which a tip of the horizontal portion of the lifting fork is to be positioned away from a rear face of the palletized load when the horizontal portion of the lifting fork is inserted into the fork receiving location, and when the support surface of the horizontal portion of the lifting fork engages the support surface of the fork receiving location during lifting of the palletized load;
monitor at least one of a manually operable control of the console device or a touch-sensitive component of the display for receipt of the cushion distance; and
in response to receipt of the cushion distance, store the cushion distance in the storage, and increase the zero point distance by the cushion distance.

9. The lifting fork positioning system of claim 1, wherein the processor component is caused to:
visually present an option for an operator of the lifting vehicle to specify a measurement adjustment distance to compensate for a difference in forward-rearward positioning of the distance sensor relative to the forward portion of the lifting vehicle;
monitor at least one of a manually operable control of the console device or a touch-sensitive component of the display for receipt of the measurement adjustment distance; and
in response to receipt of the measurement adjustment distance, store the measurement adjustment distance in the storage, and adjust the current distance based on the measurement adjustment distance prior to the comparison to the zero point distance and prior to subtraction by the zero point distance.

10. A lifting vehicle comprising:
a set of wheels to support the lifting vehicle atop a flooring surface;
a motor to drive at least one wheel of the set of wheels to move the lifting vehicle about the flooring surface;
a lifting mechanism to cooperate with a lifting fork to lift a palletized load when the lifting fork is mounted on the lifting mechanism, wherein:
the lifting fork comprises an elongate horizontal portion that extends lengthwise and forwardly of the lifting vehicle toward the palletized load when the lifting fork is mounted on the lifting mechanism;
the horizontal portion of the lifting fork comprises an elongate upwardly-facing support surface to be received in fork receiving location of a pallet of the palletized load;
the fork receiving location comprises a downwardly-facing support surface to be engaged by the upwardly-facing support surface of the horizontal portion of the lifting fork during lifting of the palletized load by the lifting vehicle via the lifting mechanism and the lifting fork;
manually operable controls to enable an operator to control the movement of the lifting vehicle about the flooring surface and to control the lifting of the palletized load by the lifting mechanism and the lifting fork; and
a lifting fork positioning system comprising:
a distance sensor oriented to recurringly detect a current distance extending forwardly from a forward portion of the lifting vehicle and to a front face of the palletized load that faces the lifting vehicle;
a display; and
a processor component and a storage storing instructions that, when executed by the processor component, cause the processor component to:
recurringly determine whether a zero point distance is currently set, wherein the zero point distance extends forwardly of the lifting vehicle and in parallel with the current distance to the front face of the palletized load; and
in response to the zero point distance being currently set:
recurringly compare lengths of the current distance and the zero point distance;
recurringly subtract the length of the zero point distance from the length of the current distance to recurringly derive a magnitude of difference between the lengths of the current distance and the zero point distance;
visually present the magnitude of the difference on the display;
visually present, on the display, an indication that the front face of the palletized load is closer to the lifting vehicle in response to the length of the current distance being greater than the length of the zero point distance; and
visually present, on the display, an indication that the front face of the palletized load is further away from the lifting vehicle in response to the length of the zero point distance being greater than the length of the current distance.

11. The lifting vehicle of claim 10, wherein the distance sensor emits at least one of sound or light toward the front face of the palletized load to be reflected back to the distance sensor, and the distance sensor analyzes the reflected sound or light to detect the current distance.

12. The lifting vehicle of claim 10, wherein the processor component is caused to, in response to the zero point distance not being currently set:
visually present an indication that the zero point distance is not currently set on the display;
visually present the current distance on the display;
await receipt of a command to set the zero point distance; and
in response to receipt of the command to set the zero point distance, store the current distance that is currently detected by the distance sensor in the storage as the zero point distance.

13. The lifting vehicle of claim 10, comprising a fork length detector to detect a length of the elongate upwardly-facing support surface of the horizontal portion of the lifting fork, wherein the processor component is caused to, in response to the zero point distance not being currently set:
visually present an indication that the zero point distance is not currently set on the display;
visually present the current distance on the display;
await receipt of a command to set the zero point distance; and
in response to receipt of the command to set the zero point distance, operate the fork length detector to detect the length of the support surface of the horizontal portion, and store the length of the support surface of the horizontal portion in the storage as the zero point distance.

14. A processor-implemented method comprising:
recurringly detecting, by a distance sensor carried by a lifting vehicle, a current distance extending forwardly from a forward portion of the lifting vehicle and to a front face of a palletized load that faces the lifting vehicle, wherein:
the lifting vehicle comprises a lifting mechanism to cooperate with a lifting fork to lift the palletized load when the lifting fork is mounted on the lifting mechanism;
the lifting fork comprises an elongate horizontal portion that extends lengthwise and forwardly of the lifting vehicle toward the palletized load when the lifting fork is mounted on the lifting mechanism;
the horizontal portion of the lifting fork comprises an elongate upwardly-facing support surface;
the palletized load comprises a pallet that defines at least one fork receiving location to receive the elongate horizontal portion; and
the fork receiving location comprises a downwardly-facing support surface to be engaged by the upwardly-facing support surface of the horizontal portion of the lifting fork to enable lifting of the palletized load by the lifting vehicle via the lifting mechanism and the lifting fork;
recurringly determining, by a processor component, whether a zero point distance is currently set, wherein the zero point distance extends forwardly of the lifting vehicle and in parallel with the current distance to the front face of the palletized load; and
in response to the zero point distance being currently set:
recurringly comparing, by the processor component, lengths of the current distance and the zero point distance;
recurringly subtracting, by the processor component, the length of the zero point distance from the length of the current distance to recurringly derive a magnitude of difference between the lengths of the current distance and the zero point distance;
visually presenting, on a display, the magnitude of the difference;
visually presenting, on the display, an indication that the front face of the palletized load is closer to the lifting vehicle in response to the length of the current distance being greater than the length of the zero point distance; and
visually presenting, on the display, an indication that the front face of the palletized load is further away from the lifting vehicle in response to the length of the zero point distance being greater than the length of the current distance.

15. The processor-implemented method of claim 14, comprising:
emitting, from the distance sensor, at least one of sound or light toward the front face of the palletized load to be reflected back to the distance sensor; and
analyzing, at the distance sensor, the reflected sound or light to detect the current distance.

16. The processor-implemented method of claim 14, comprising visually presenting, on the display, a representation of relative positions of the lifting fork and the palletized load.

17. The processor-implemented method of claim 14, comprising, in response to the zero point distance not being currently set:
visually presenting, on the display, an indication that the zero point distance is not currently set;
visually presenting, on the display, the current distance;
monitoring, by the processor component, at least one of a manually operable control or a touch-sensitive component of the display for receipt of a command to set the zero point distance; and
in response to receipt of the command to set the zero point distance, storing the current distance that is currently detected by the distance sensor in a storage coupled to the processor component as the zero point distance.

18. The processor-implemented method of claim 14, comprising, in response to the zero point distance not being currently set:
visually presenting, on the display, an indication that the zero point distance is not currently set;
visually presenting, on the display, the current distance;
monitoring, by the processor component, at least one of a manually operable control or a touch-sensitive component of the display for receipt of a command to set the zero point distance; and
in response to receipt of the command to set the zero point distance, operating a fork length detector to detect a length of the elongate upwardly-facing support surface of the horizontal portion, and storing the length of the support surface of the horizontal portion in a storage coupled to the processor component as the zero point distance.

19. The processor-implemented method of claim 18, wherein operating the fork length detector to detect the length of the elongate upwardly-facing support surface of the horizontal portion comprises at least one of:
an optically scanning, by the fork length detector, the support surface of the horizontal portion of the lifting fork;
an optical scanning, by the fork length detector, one or more surfaces of the lifting fork for an indicia that indicates the length of the support surface; and
electromagnetically transmitting electric power to energize a RFID tag carried by the lifting fork and receiving, by the fork length detector, a signal from the RFID tag that conveys an indication of the length of the support surface.

20. The processor-implemented method of claim 18, comprising:
visually presenting, on the display, an option for an operator of the lifting vehicle to specify a cushion distance at which a tip of the horizontal portion of the lifting fork is to be positioned away from a rear face of the palletized load when the horizontal portion of the lifting fork is inserted into the fork receiving location, and when the support surface of the horizontal portion of the lifting fork engages the support surface of the fork receiving location during lifting of the palletized load;
monitoring, by the processor component, at least one of a manually operable control or a touch-sensitive component of the display for receipt of the cushion distance; and
in response to receipt of the cushion distance, storing the cushion distance in a storage coupled to the processor component and increasing the zero point distance by the cushion distance.

21. The processor-implemented method of claim 14, comprising:
visually presenting, on the display, an option for an operator of the lifting vehicle to specify a measurement adjustment distance to compensate for a difference in forward-rearward positioning of the distance sensor relative to the forward portion of the lifting vehicle;
monitoring, by the processor component, at least one of a manually operable control or a touch-sensitive component of the display for receipt of the measurement adjustment distance; and
in response to receipt of the measurement adjustment distance, storing the measurement adjustment distance in a storage coupled to the processor component, and adjusting the current distance based on the measurement adjustment distance prior to the comparison to the zero point distance and prior to subtraction by the zero point distance.

22. A machine-readable non-transitory storage medium storing instructions that, when executed by a processor component, causes the processor component to:
recurringly detect, by a distance sensor carried by a lifting vehicle, a current distance extending forwardly from a forward portion of the lifting vehicle and to a front face of a palletized load that faces the lifting vehicle, wherein:
the lifting vehicle comprises a lifting mechanism to cooperate with a lifting fork to lift the palletized load when the lifting fork is mounted on the lifting mechanism;
the lifting fork comprises an elongate horizontal portion that extends lengthwise and forwardly of the lifting vehicle toward the palletized load when the lifting fork is mounted on the lifting mechanism;
the horizontal portion of the lifting fork comprises an elongate upwardly-facing support surface;
the palletized load comprises a pallet that defines at least one fork receiving location to receive the elongate horizontal portion; and
the fork receiving location comprises a downwardly-facing support surface to be engaged by the upwardly-facing support surface of the horizontal portion of the lifting fork to enable lifting of the palletized load by the lifting vehicle via the lifting mechanism and the lifting fork;
recurringly determine whether a zero point distance is currently set, wherein the zero point distance extends forwardly of the lifting vehicle and in parallel with the current distance to the front face of the palletized load; and
in response to the zero point distance being currently set:
recurringly compare lengths of the current distance and the zero point distance;
recurringly subtract the length of the zero point distance from the length of the current distance to recurringly derive a magnitude of difference between the lengths of the current distance and the zero point distance;
visually present the magnitude of the difference on a display;
visually present an indication that the front face of the palletized load is closer to the lifting vehicle on the display in response to the length of the current distance being greater than the length of the zero point distance; and
visually present an indication that the front face of the palletized load is further away from the lifting vehicle on the display in response to the length of the zero point distance being greater than the length of the current distance.

23. The machine-readable non-transitory storage medium of claim 22, wherein the processor component is caused to, in response to the zero point distance not being currently set:
visually present an indication that the zero point distance is not currently set on the display;
visually present the current distance on the display;
monitor at least one of a manually operable control or a touch-sensitive component of the display for receipt of a command to set the zero point distance; and
in response to receipt of the command to set the zero point distance, store the current distance that is currently detected by the distance sensor in a storage coupled to the processor component as the zero point distance.

24. The machine-readable non-transitory storage medium of claim 22, wherein the processor component is caused to, in response to the zero point distance not being currently set:
visually present an indication that the zero point distance is not currently set on the display;
visually present the current distance on the display;
monitor at least one of a manually operable control or a touch-sensitive component of the display for receipt of a command to set the zero point distance; and
in response to receipt of the command to set the zero point distance, operate a fork length detector to detect a length of the elongate upwardly-facing support surface of the horizontal portion, and store the length of the support surface of the horizontal portion in a storage coupled to the processor component as the zero point distance.

25. The machine-readable non-transitory storage medium of claim 22, wherein the processor component is caused to:
visually present, on the display, an option for an operator of the lifting vehicle to specify a cushion distance at which a tip of the horizontal portion of the lifting fork is to be positioned away from a rear face of the palletized load when the horizontal portion of the lifting fork is inserted into the fork receiving location, and when the support surface of the horizontal portion of the lifting fork engages the support surface of the fork receiving location during lifting of the palletized load;
monitor at least one of a manually operable control or a touch-sensitive component of the display for receipt of the cushion distance; and
in response to receipt of the cushion distance, store the cushion distance in a storage coupled to the processor component and increasing the zero point distance by the cushion distance.

26. The machine-readable non-transitory storage medium of claim 22, wherein the processor component is caused to:
visually present, on the display, an option for an operator of the lifting vehicle to specify a measurement adjustment distance to compensate for a difference in forward-rearward positioning of the distance sensor relative to the forward portion of the lifting vehicle;
monitor at least one of a manually operable control or a touch-sensitive component of the display for receipt of the measurement adjustment distance; and
in response to receipt of the measurement adjustment distance, store the measurement adjustment distance in a storage coupled to the processor component, and adjust the current distance based on the measurement adjustment distance prior to the comparison to the zero point distance and prior to subtraction by the zero point distance.

27. The machine-readable non-transitory storage medium of claim 22, wherein the processor component is caused to:
visually present, on the display, an option for an operator of the lifting vehicle to specify a measurement adjustment distance to compensate for a difference in forward-rearward positioning of the distance sensor relative to the forward portion of the lifting vehicle;
monitor at least one of a manually operable control or a touch-sensitive component of the display for receipt of the measurement adjustment distance; and
in response to receipt of the measurement adjustment distance, provide the measurement adjustment distance to the distance sensor to enable the distance sensor to adjust the current distance based on the measurement adjustment distance prior to provision of the current distance to the processor component for comparison to the zero point distance and subtraction by the zero point distance.
